(19) United States
(12) Patent Application Publication
(10) Pub. No.: US 2024/0276052 A1
(43) Pub. Date: Aug. 15, 2024

(54) INFRARED COVERAGE, SELECTION, AND CALIBRATION IN A MEDIA SYSTEM

(71) Applicant: CAAVO INC, Milpitas, CA (US)

(72) Inventors: Ashish AGGARWAL, Stevenson Ranch, CA (US); Sharath SATHEESH, Bangalore (IN); Narayanan BHATTATHIRIPAD, Bangalore (IN); Rajasekhar KOLLIPARA, Bangalore (IN); James K. JOSE, Bangalore (IN)

(73) Assignee: CAAVO INC, Milpitas, CA (US)

(21) Appl. No.: 18/438,157

(22) Filed: Feb. 9, 2024

(30) Foreign Application Priority Data
Feb. 10, 2023 (IN) 202341008734

(51) Int. Cl. H04N 21/422

(52) U.S. Cl. CPC H04N 21/42221

(57) ABSTRACT

Embodiments are described herein for providing infrared (IR) coverage in a media system, IR codeset selection, and/or calibration of IR blasters. In one aspect, a triggering event is detected and an action to be performed by a device is determined. It is determined that the device is controllable using IR signals. An IR command signal including instructions to perform the action is transmitted to the device. In another aspect, a codeset is selected. A determination of whether a signature signal associated with a device indicates a state corresponding to a command including an IR code of an IR codeset transmitted to the device is made. If so, the IR codeset is associated with the device. Otherwise, another command including an IR code of another IR codeset is transmitted. In another aspect, an IR blaster is calibrated based on whether a signature signal indicates a state corresponding to a transmitted command.

### CROSS-REFERENCE TO RELATED APPLICATIONS

This application claims priority to India Provisional Application No. 202341008734, filed on Feb. 10, 2023, entitled “INFRARED COVERAGE, SELECTION, AND CALIBRATION IN A MEDIA SYSTEM,” which is incorporated by reference herein in its entirety.

This application is related to the following U.S. patent applications, which are incorporated by reference herein:

U.S. patent application Ser. No. 14/945,175, filed on Nov. 18, 2015, now issued, and entitled “Seamless Setup and Control for Home Entertainment Devices and Content,” which claims priority to U.S. Provisional Application No. 62/081,430, filed 62/081,430, the entirety of which is incorporated by reference;

U.S. patent application Ser. No. 16/250,808, filed on Jan. 17, 2019, now issued, and entitled “Device Identification and Power State Determination Using Media Device Information,” which claims priority to Indian Patent Application No. 201841002345, filed Jan. 19, 2018, the entirety of which is incorporated by reference;

U.S. patent application Ser. No. 17/866,177, filed on Jul., 15, 2022, and entitled “Determining State Signatures for Consumer Electronic Devices Coupled to an Audio/Video Switch,” which is a continuation application of U.S. patent application Ser. No. 16/862,811, filed Apr. 30, 2020, now issued, entitled “Determining State Signatures for Consumer Electronic Devices Coupled to an Audio/Video Switch,” which claims priority to Indian Provisional Patent Application No. 201741004798, filed Feb. 10, 2017, the entireties of which are incorporated by reference;

U.S. patent application Ser. No. 15/892,215, filed on Feb. 8, 2018, now issued, and entitled “Determining State Signatures for Consumer Electronic Devices Coupled to an Audio/Video Switch,” which also claims priority to Indian Provisional Application No. 201741004798, filed Feb. 10, 2017, the entirety of which is incorporated by reference;

U.S. patent application Ser. No. 14/945,201, filed on Nov. 18, 2015, now abandoned, and entitled “Automatic Detection of a Power Status of an Electronic Device and Control Schemes Based Thereon,” which claims priority to U.S. Provisional Application No. 62/081,397, filed Nov. 18, 2014, the entirety of which is incorporated by reference;

U.S. patent application Ser. No. 17/934,312, filed on Sep. 22, 2022, and entitled “STATE DETECTION VIA POWER MONITORING,” which claims priority to U.S. Provisional Application No. 63/247,622, filed Sep. 23, 2021, the entirety of which is incorporated by reference;

U.S. patent application Ser. No. 17/935,650, filed on Sep. 27, 2022, and entitled “POWER STATE DETECTION VIA AUDIO SIGNAL CAPTURE,” which claims priority to U.S. Provisional Application No. 63/249,211, filed Sep. 28, 2021, the entirety of which is incorporated by reference.

### BACKGROUND

A media system (e.g., an entertainment system) may include one or more devices with infrared (IR) receivers. Such devices may be controlled by IR signals. Control in this manner typically relies on line of sight between the device sending the IR signal (e.g., an IR transmitter of a remote control device) and the device receiving the IR signal (e.g., the IR receiver of a television). As such, a clear line of sight between the IR transmitter and IR receiver is needed to control such devices.

### BRIEF SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems, and apparatuses are described herein for providing infrared (IR) coverage in a media system, IR codeset selection, and/or calibration of IR blasters. In one aspect, a switching device comprises a plurality of ports and a plurality of IR blaster components. At least one of the plurality of ports is communicatively coupled to a first consumer electronic device. The plurality of IR blaster components is oriented to project IR light in different directions. The switching device detects a triggering event. The switching device, responsive to detecting the triggering event, determines an action to be performed by the first consumer electronic device. The switching device determines that the first consumer electronic device is controllable using IR signals. The switching device transmits, by the plurality of IR blaster components, an IR command signal to the first consumer electronic device, the IR command signal comprising instructions to perform the determined action.

In another aspect, a system comprises an IR blaster component and a state identification component. The IR blaster component is operable to transmit IR signals to a plurality of consumer electronic devices. The state identification component is operable to determine the state of the plurality of consumer electronic devices. The system configured to: transmit, by the IR blaster component, a first IR command signal to a consumer electronic device of the plurality of consumer electronic devices, the first IR command signal comprising a first IR code of a first IR codeset; receive a first signature signal associated with the consumer electronic device; determine, by the state identification component, that the first signature signal is not indicative of a first state corresponding to the first IR command signal; responsive to determining that the first signature signal is not indicative of the first state, transmit, by the IR blaster component, a second IR command signal to the consumer electronic device, the second IR command signal comprising a second IR code of a second IR codeset; receive a second signature signal associated with the consumer electronic device; determine, by the state identification component, that the second signature signal is indicative of a second state corresponding to the second IR command signal; and associate the second IR codeset with the consumer electronic device.

In another aspect, a system comprises one or more IR blasters. The system transmits, by the one or more IR blasters, one or more respective IR signals to a consumer electronic device, the one or more respective IR signals corresponding to a command The system receives a signature signal associated with a consumer electronic device. The system determines whether the signature signal is indicative of a state corresponding to the command. Responsive to a determination of whether the signature signal is indicative of the state, the system calibrates at least one of the one or more IR blasters.

### BRIEF DESCRIPTION OF THE DRAWINGS/FIGURES

The accompanying drawings, which are incorporated herein and form a part of the specification, illustrate embodiments and, together with the description, further serve to explain the principles of the embodiments and to enable a person skilled in the pertinent art to make and use the embodiments.

FIG. 1A is a block diagram of a media system configured for providing IR coverage, selection, and/or calibration, according to an exemplary embodiment.

FIG. 1B is a block diagram of a media system configured for providing IR coverage, selection, and/or calibration, according to another exemplary embodiment.

FIG. 2 is a block diagram of a media system that includes a switching device configured for providing IR coverage, selection, and/or calibration, according to another exemplary embodiment.

FIG. 3 is a flowchart of a process for providing IR coverage in a media system, according to an exemplary embodiment.

FIG. 4 depicts an example implementation of a switching device that provides IR coverage for a media system.

FIG. 5A is a flowchart of a process for automatic selection of an IR codeset to control a consumer electronic device, according to an exemplary embodiment.

FIG. 5B is a flowchart of a process for associating an IR codeset with a consumer electronic device, according to an exemplary embodiment.

FIG. 5C is a flowchart of a process for utilizing an associated IR codeset with respect to a consumer electronic device, according to an exemplary embodiment.

FIG. 6 is a flowchart of a process for determining whether a signature signal is indicative of a state corresponding to a command, according to an exemplary embodiment.

FIG. 7 is a flowchart of a process for IR blaster calibration, according to an exemplary embodiment.

FIG. 8 is a flowchart of a process for calibrating an IR blaster, according to an exemplary embodiment.

FIG. 9 is a block diagram of a media system configured for IR coverage, selection, and/or calibration, according to another exemplary embodiment.

FIG. 10 is a block diagram of a media system configured for IR coverage, selection, and/or calibration, according to another exemplary embodiment.

FIG. 11 is a block diagram of a computer system, according to an exemplary embodiment.

Embodiments will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

### I. Introduction

The present specification discloses numerous example embodiments. The scope of the present patent application is not limited to the disclosed embodiments, but also encompasses combinations of the disclosed embodiments, as well as modifications to the disclosed embodiments.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner

Numerous exemplary embodiments are described herein. Any section/subsection headings provided herein are not intended to be limiting. Embodiments are described throughout this document, and each embodiment may be eligible for inclusion within multiple different sections or subsections. Furthermore, it is contemplated that the disclosed embodiments may be combined with each other in any manner That is, the embodiments described herein are not mutually exclusive of each other and may be practiced and/or implemented alone, or in any combination.

A method for providing infrared (IR) coverage in a media system is described herein. The method is performed by a switching device comprising a plurality of ports and a plurality of IR blaster components. At least one of the plurality of ports is communicatively coupled to a first consumer electronic device. The plurality of IR blaster components is oriented to project IR light in different directions. The method comprises: detecting a triggering event; responsive to detecting the triggering event, determining an action to be performed by the first consumer electronic device; determining that the first consumer electronic device is controllable using IR signals; transmitting, by the plurality of IR blaster components, an IR command signal to the first consumer electronic device, the IR command signal comprising instructions to perform the determined action.

In an implementation of the foregoing method for providing IR coverage, the triggering event comprises at least one of: the switching device receiving a command via a network interface; the switching device detecting a wireless control signal sent from a remote control device; a change in state of the first consumer electronic device; or a change in state of a second consumer electronic device.

In an implementation of the foregoing method for providing IR coverage, the action to be performed by the first consumer electronic device comprises entering a state; and the IR command signal comprises instructions to enter the state.

In an implementation of the foregoing method for providing IR coverage, further comprising: responsive to transmitting the IR command signal, determining that the first consumer electronic device is not in the state; and responsive to determining that the first consumer electronic device is not in the state, perform a corrective action.

In an implementation of the foregoing method for providing IR coverage, said performing the corrective action comprises recalibrating at least one IR blaster of the plurality of IR blasters.

In an implementation of the foregoing method for providing IR coverage, the first IR command signal comprises a first IR code of a first IR codeset, and said performing the corrective action comprises: transmits, to the first consumer electronic device, a second IR command signal comprising a second IR code of a second IR codeset; determines that the first consumer electronic device is in the state; and associates the second IR codeset with the first consumer electronic device.

In an implementation of the foregoing method for providing IR coverage, further comprising: determining an IR codeset associated with the first consumer electronic device based on a codeset map; and transmitting, by the plurality of IR blaster components, the IR command signal to the first consumer electronic device based on the determined IR codeset.

In an implementation of the foregoing method for providing IR coverage, the plurality of IR blaster components comprises a plurality of IR light-emitting diodes (LEDs).

A switching device configured to provide IR coverage is described herein. The switching device configured to perform any of the foregoing methods for providing IR coverage in a media system.

A computer readable storage medium configured to provide IR coverage is described herein. The computer readable storage medium comprising instructions that, when executed by a processor, causes the processor to perform any of the foregoing methods for providing IR coverage in a media system.

A system configured to provide IR coverage is described herein. The system configured to perform any of the foregoing methods for providing IR coverage in a media system.

In an implementation of the foregoing system configured to provide IR coverage, the system comprises the foregoing switching device.

A method for providing IR codeset selection is described herein. The method comprises: transmitting, by an IR blaster component operable to transmit IR signals to a plurality of consumer electronic devices, a first IR command signal to a consumer electronic device of the plurality of consumer electronic devices, the first IR command signal comprising a first IR code of a first IR codeset; receiving a first signature signal associated with the consumer electronic device; determining, by a state identification component operable to determine the state of the plurality of consumer electronic devices, that the first signature signal is not indicative of a first state corresponding to the first IR command signal; responsive to determining that the first signature signal is not indicative of the first state, transmitting, by the IR blaster component, a second IR command signal to the consumer electronic device, the second IR command signal comprising a second IR code of a second IR codeset; receiving a second signature signal associated with the consumer electronic device; determining, by the state identification component, that the second signature signal is indicative of a second state corresponding to the second IR command signal; and associating the second IR codeset with the consumer electronic device.

In an implementation of the foregoing method for providing IR codeset selection, wherein said associating the second IR codeset with the consumer electronic device comprises storing an association between the second IR codeset and the consumer electronic device in a codeset map.

In an implementation of the foregoing method for providing IR codeset selection, the method further comprises transmitting to the consumer electronic device, by the IR blaster component, subsequent IR command signals based on IR codes of the second IR codeset.

In an implementation of the foregoing method for providing IR codeset selection, wherein said determining that the second signature signal is indicative of the second state corresponding to the second IR command signal comprises: comparing the second signature signal to one or more reference signatures; and determining that a level of similarity between the second signature signal and the one or more reference signatures meets a threshold condition.

In an implementation of the foregoing method for providing IR codeset selection, wherein the second state comprises: a powered off state; a powered on state; or a standby state.

In an implementation of the foregoing method for providing IR codeset selection, wherein the first signature signal comprises at least one of: a power signature signal; an audio signal captured by a microphone; a video signal received by the system; one or more network data packets; or a radio frequency signal.

In an implementation of the foregoing method for providing IR codeset selection, wherein said transmitting the first IR command signal comprises transmitting the first IR command signal utilizing a plurality of IR blaster components, the plurality of IR blaster components comprising the IR blaster component, the plurality of IR blaster components oriented to project IR light in different directions.

In an implementation of the foregoing method for providing IR codeset selection, wherein said transmitting the second IR command signal comprises transmitting the second IR command signal utilizing a plurality of IR blaster components, the IR blaster components comprising the IR blaster component, the plurality of IR blaster components oriented to project IR light in different directions.

In an implementation of the foregoing method for providing IR codeset selection, wherein the first state and the second state are the same state.

A switching device configured to provide IR codeset selection is described herein. The switching device configured to perform any of the foregoing methods for providing IR codeset selection.

In an implementation of the foregoing switching device configured to provide IR codeset selection, the switching device comprises a plurality of ports and a switch circuit. Each port of the plurality of ports is coupled to a respective one of the plurality of consumer electronic devices. The switch circuit is operable to selectively connect the consumer electronic device to another consumer electronic device of the plurality of consumer electronic devices.

A computer readable storage medium configured to provide IR codeset selection is described herein. The computer readable storage medium comprising instructions that, when executed by a processor, performs any of the foregoing methods for providing IR codeset selection.

A system configured to provide IR codeset selection is described herein. The system configured to perform any of the foregoing methods for providing IR codeset selection.

In an implementation of the foregoing system configured to provide IR codeset selection, the system comprises the foregoing switching device.

A method for providing IR calibration is described herein. The method comprises: transmitting, by one or more infrared (IR) blasters, one or more respective IR signals to a consumer electronic device, the one or more respective IR signals corresponding to a command; receiving a signature signal associated with a consumer electronic device; determining whether the signature signal is indicative of a state corresponding to the command; and responsive to said determining whether the signature signal is indicative of the state, calibrating at least one of the one or more IR blasters.

In an implementation of the foregoing method for providing IR calibration, wherein said calibrating the at least one of the one or more IR blasters comprises at least one of: decreasing an output current of at least one IR blaster of the one or more infrared blasters; or increasing an output current of at least one IR blaster of the one or more infrared blasters.

In an implementation of the foregoing method for providing IR calibration, wherein said calibrating the at least one of the one or more IR blasters of the switching device comprises at least one of: determining a minimum output current of the at least one IR blaster of the one or more IR blasters to transmit a respective IR signal of the one or more respective IR signals to the consumer electronic device; or determining a maximum output current of the at least one IR blaster of the one or more IR blasters to transmit the respective IR signal of the one or more respective IR signals to the consumer electronic device.

In an implementation of the foregoing method for providing IR calibration, wherein said determining the maximum output current of the at least one IR blaster comprises: determining a magnitude of an output current of the at least one IR blaster wherein the respective IR signal saturates an IR receiver of the consumer electronic device.

In an implementation of the foregoing method for providing IR calibration, wherein said determining whether the signature signal is indicative of the state corresponding to the command comprises: comparing the signature signal to one or more reference signatures; and determining that a level of similarity between the signature signal and the one or more reference signatures meets a threshold condition.

In an implementation of the foregoing method for providing IR calibration, the signature signal comprises at least one of: a power signature signal; an audio signal captured by a microphone; a video signal received by the system; one or more network data packets; or a radio frequency signal.

A switching device configured to provide IR calibration is described herein. The switching device is configured to perform any of the foregoing methods for providing IR calibration.

In an implementation of the foregoing switching device configured to provide IR calibration, the switching device comprises a plurality of ports and a switch circuit. Each of the plurality of ports are coupled to a respective one of the plurality of consumer electronic devices. The switch circuit is operable to selectively connect the consumer electronic device to another consumer electronic device of the plurality of consumer electronic devices.

A computer readable storage medium configured to provide IR calibration is described herein. The computer readable storage medium comprising instructions that, when executed by a processor, performs any of the foregoing methods for providing IR calibration.

A system configured to provide IR calibration is described herein. The system is configured to perform any of the foregoing methods for providing IR calibration. In an implementation of the foregoing system configured to provide IR calibration, the system comprises the foregoing switching device.

### II. Example Embodiments

Embodiments are provided for providing infrared (IR) coverage, selection, and/or calibration in a media system. For example, a device (e.g., a switching device or other consumer electronic device) may comprise one or more IR blaster components (e.g., IR light emitting diodes (LEDs)). In embodiments wherein the device comprises more than one IR blaster component, each IR blaster component may be oriented to project IR light in a different direction. In one aspect, the device is configured to provide IR coverage in a media system by detecting a triggering event and determining an action to be performed by another consumer electronic device (e.g., a television, a DVD player, a Blu-ray player, a video game console, a streaming media device, an HDTV, a projector, a speaker, a set top box, and/or the like). The device transmits an IR command signal to the other consumer electronic device using the one or more IR blaster components. The IR command signal includes instructions to perform the determined action. In another aspect, the device is configured to (e.g., automatically) determine and select an IR codeset to control a consumer electronic device in a media system. In another aspect, the device is configured to calibrate the one or more IR blaster components.

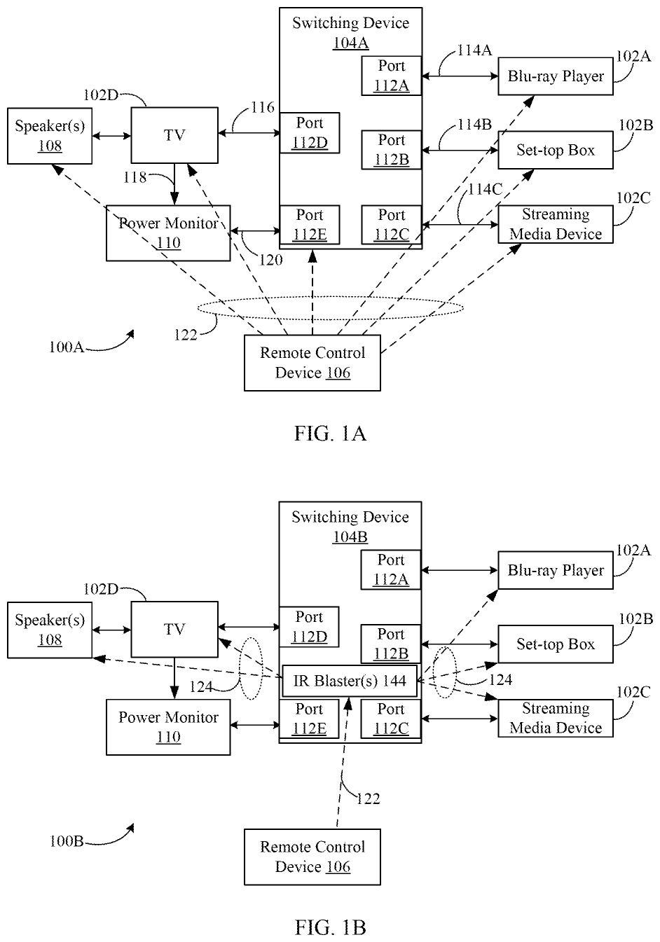

Embodiments may be configured in various ways in various embodiments. For example, FIG. 1 is a block diagram of a media system 100 (“system 100” hereinafter) configured for providing IR coverage, selection, and/or calibration, according to an exemplary embodiment. As shown in FIG. 1A, system 100 includes a plurality of consumer electronic devices 102A-102D, a switching device 104A, a remote control device 106, one or more speakers 108 (“speakers 108” hereinafter), and a power monitor 110. Switching device 104A may be a high-definition multimedia interface (HDMI) based switching device, but the embodiments disclosed herein are not so limited.

Consumer electronic devices 102A-102C are configured to provide media content signals (e.g., media content signals 114A, 114B, and 114C, respectively) for playback and are referred to as “source” devices. Media content signals may include audio signals, video signals, or a combination of audio and video signals. Consumer electronic device 102D is configured to receive media content signals (e.g., media content signals 116) and is referred to as a “sink” device. Consumer electronic device 102D is coupled to speakers 108. Speakers 108 may be incorporated in consumer electronic device 102D, or alternatively, may be part of an external sound system that is coupled to consumer electronic device 102D and/or switching device 102. In an embodiment in which speakers 108 are part of an external sound system, speakers 108 may be communicatively coupled to consumer electronic device 102D and/or switching device 102 via a wired interface (e.g., an HDMI cable, an optical cable, a universal serial bus (USB) cable, an Ethernet cable, etc.) or wireless interface (e.g., Bluetooth, Wi-Fi, etc.).

As shown in FIG. 1A, consumer electronic device 102D and switching device 104A are coupled to a power monitor 110. Power monitor 110 is configured to receive power signals (e.g., power signals 118) and provide power signature signals (e.g., power signature signals 120). Power monitor 110 may be incorporated in consumer electronic device 102D, may be incorporated in switching device 104A, or may be part of an external power monitoring system that is coupled to consumer electronic device 102D and/or switching device 104A. In an embodiment in which power monitor 110 is external to switching device 104A and/or consumer electronic device 102D, power monitor 110 may be communicatively coupled to consumer electronic device 102D and/or switching device 104A via one or more wired interfaces (e.g., an HDMI cable, an optical cable, a universal serial bus (USB) cable, an Ethernet cable, etc.) and/or wireless interfaces (e.g., Bluetooth, Wi-Fi, etc.). While only one power monitor is depicted in FIG. 1A, it is also contemplated herein that multiple power monitors may be included in a media system. For instance, each of consumer electronic devices 102A-102C may include (or be coupled to) a respective power monitor that functions in a similar manner to power monitor 110. Further details regarding power monitoring are described elsewhere herein, for example with respect to FIG. 6. Additional details regarding power monitors are described in U.S. patent application Ser. No. 14/945,201, entitled “Automatic Detection of a Power Status of an Electronic Device and Control Schemes based thereon,” and U.S. patent application Ser. No. 17/934,312, entitled “STATE DETECTION VIA POWER MONITORING,” each of which are incorporated by reference herein in their respective entireties.

As shown in FIG. 1A, consumer electronic device 102A is coupled to a first port 112A of switching device 104A, consumer electronic device 102B is coupled to a second port 112B of switching device 104A, consumer electronic device 102C is coupled to a third port 112C of switching device 104A, consumer electronic device 102D is coupled to a fourth port 112D of switching device 104A, and power monitor 110 is coupled to a fifth port 112E of switching device 104A. Examples of ports 112A-112E include, but are not limited to, HDMI ports, USB ports, optical ports, and/or the like. As further shown in FIG. 1A, consumer electronic device 102A is a Blu-ray player, consumer electronic device 102B is a set-top box, consumer electronic device 102C is a streaming media device, and consumer electronic device 102D is a television (TV). Examples of a streaming media device include, but are not limited to, a Roku™ device, an AppleTV™ device, a Chromecast TM , and the like. The depiction of these particular electronics devices is merely for illustrative purposes. It is noted that while FIG. 1A shows that switching device 104A includes five ports 112A-112E, switching device 104A may include any number of ports, and therefore, may be coupled to any number of consumer electronic devices. As described with respect to FIG. 1A, ports 112A-112D are ports for receiving and/or providing media content signals (e.g., AV ports) and port 112E is a port for receiving data signals (e.g., an input/output (IO) port); however, switching device 104A may include other types of ports (not shown in FIG. 1A), such as, but not limited to network ports and/or the like.

Switching device 104A is configured to select (e.g., switch between) different media content source devices that are coupled to ports 112A-112C (e.g., consumer electronic device 102A, consumer electronic device 102B or consumer electronic device 102C) and provide an output signal (e.g., media content signals 116) comprising audio and/or video signals (e.g., media content signals 114A, media content signals 114B or media content signals 114C) provided by the selected media content source device. Media content signals 116 are provided to consumer electronic device 102D that is coupled to port 112D. Media signals 116 may also be provided to any other device capable of playing back audio and/or video signals (e.g., speakers 108, secondary displays (not shown in FIG. 1A), etc.) that may be coupled consumer electronic device 102D and/or to port 112D and/or other port(s) (not shown) of switching device 104A.

Remote control device 106 may be operable to control any or all of consumer electronic devices 102A-102D, switching device 102, and/or speakers 108 by providing respective control signals 122. Remote control device 106 may transmit control signals 122 control signals via an IR-based protocol, a radio frequency (RF) based protocol, and/or an internet protocol (IP) based protocol. Remote control device 106 may include a display screen and/or one or more physical interface elements (e.g., buttons, sliders, jog shuttles, etc.). In accordance with an embodiment, the display screen (or a portion thereof) may be a capacitive touch display screen. The display screen may be configured to display one or more virtual interface elements (e.g., icons, buttons, search boxes, etc.). The display screen may be configured to enable a user to interact, view, search, and/or select content for viewing via any of switching device 104A, consumer electronic devices 102A-102D, and/or speakers 108. Furthermore, remote control device 106 may include a microphone, not shown in FIG. 1A. The microphone may be configured to capture audio signals. Remote control device 106 may be configured to provide captured audio signals (e.g., as remote signals 122) to one or more of switching device 104A, consumer electronic devices 102A-102D, and/or speakers 108 to enable a user to interact, view, search, and/or select content, determine a state of one or more of consumer electronic devices 102A-102D and/or speakers 108, and/or perform functions related to audio input features of one or more of switching device 104A, consumer electronic devices 102A-102D, speakers 108, and/or an application executed by switching device 104A, consumer electronic devices 102A-102D, and/or speakers 108. Additional details regarding determining a state of a consumer electronic device based on captured audio signals are discussed with respect to FIG. 6. Types of remote control device 106 include, but are not limited to, infrared (IR) remote controllers, Bluetooth controllers, mobile phones, universal remotes, and/or the like. As shown in FIG. 1A, system 100 includes one remote control device 106. Alternatively, multiple remote control devices may be used. For instance, each of switching device 104A, consumer electronic devices 102A-102D, and/or speakers 108 may be controlled via a respective remote control device.

Switching device 104A may be configured to provide IR coverage in a media system, select an IR codeset for controlling a consumer electronic device (e.g., one or more of consumer electronic devices 102A-102D and/or speakers 108), and/or calibrate an IR blaster component of switching device 104A. For instance, in one aspect, switching device 104A is configured to transmit one or more IR command signals to one or more of consumer electronic devices 102A-102D, remote control device 106, and/or speakers 108. Switching device 104 may include one or more IR blasters for transmitting IR command signals. For example, FIG. 1B is a block diagram of a media system 100B (“system 100B” hereinafter) configured for providing IR coverage, selection, and/or calibration, according to another exemplary embodiment. System 100B is an example of 100A, as described above with respect to FIG. 1. As shown in FIG. 1B, system 100B includes a plurality of consumer electronic devices 102A-102D, remote control device 106, speakers 108, and a power monitor 110, as described above with respect to FIG. 1A, and switching device 104B.

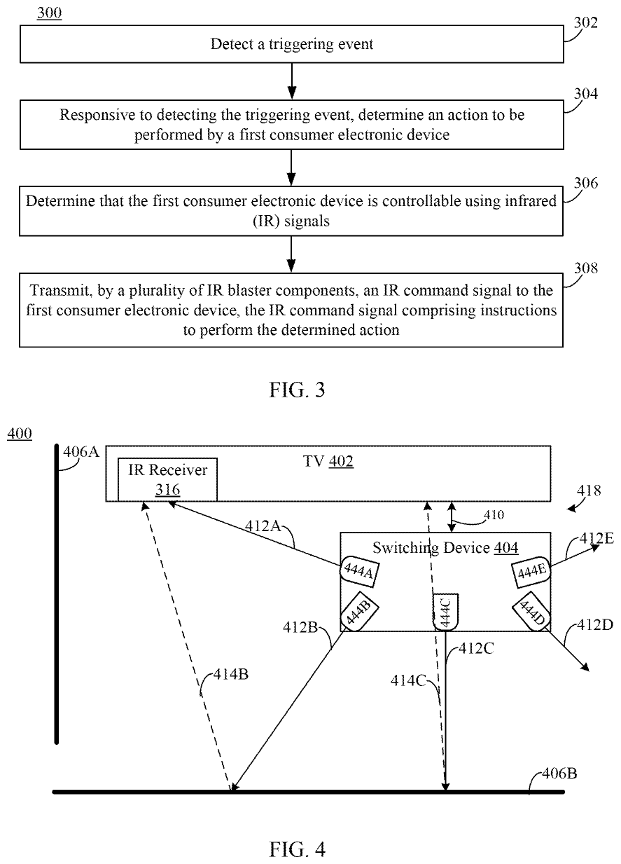

Switching device 104B is an example of switching device 104A, as described above with respect to FIG. 1A, and is configured to operate in a similar manner as switching device 104A. As shown in FIG. 1B, switching device 104 includes ports 112A-112E, as described above with respect to FIG. 1A, and one or more IR blasters 144 (“IR blasters 144” hereinafter). IR blasters comprises one or more IR blasters (also referred to as “IR blaster components” herein) configured to project IR light. In accordance with one or more embodiments, and as discussed with respect to FIGS. 3 and 4 below, different IR blasters of IR blasters 144 are oriented in a manner to project IR light in different directions. In this context, the IR light from two or more IR blasters may or may not overlap. IR blasters 144 may project a light in a linear, conical, or other manner, as would be understood by one ordinarily skilled in the relevant art(s) having benefit of this disclosure. In accordance with an embodiment, IR blasters 144 are IR light-emitting diodes (LEDs); however, embodiments disclosed herein are not so limited. As shown in FIG. 1B, IR blasters 144 are incorporated in switching device 104B; however, it is also contemplated herein that IR blasters 144 may include one or more external IR blasters coupled to switching device 104B (e.g., via port(s), control interface(s), or network face(s) of switching device 104B, not shown in FIG. 1B).

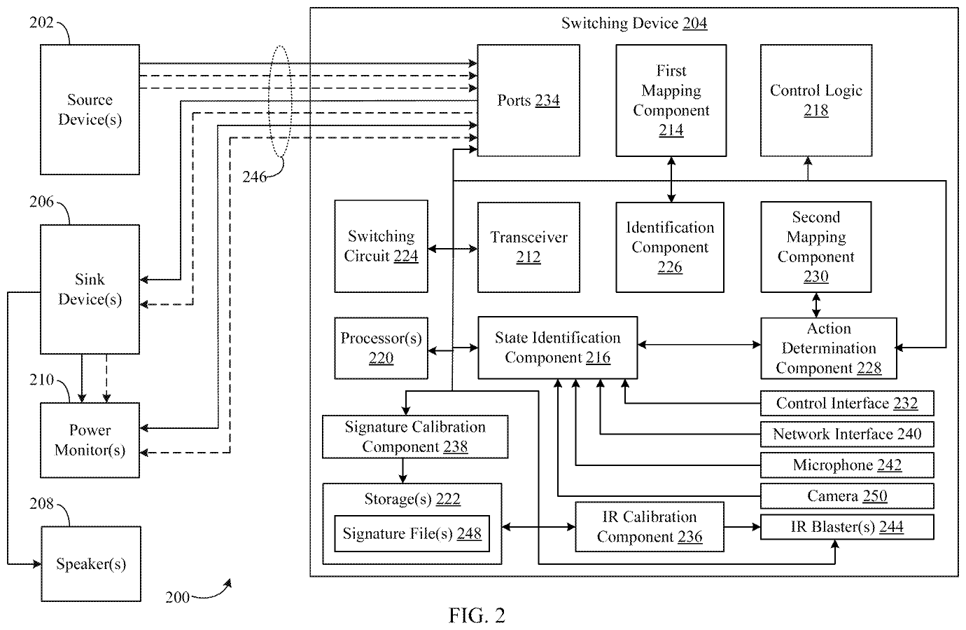

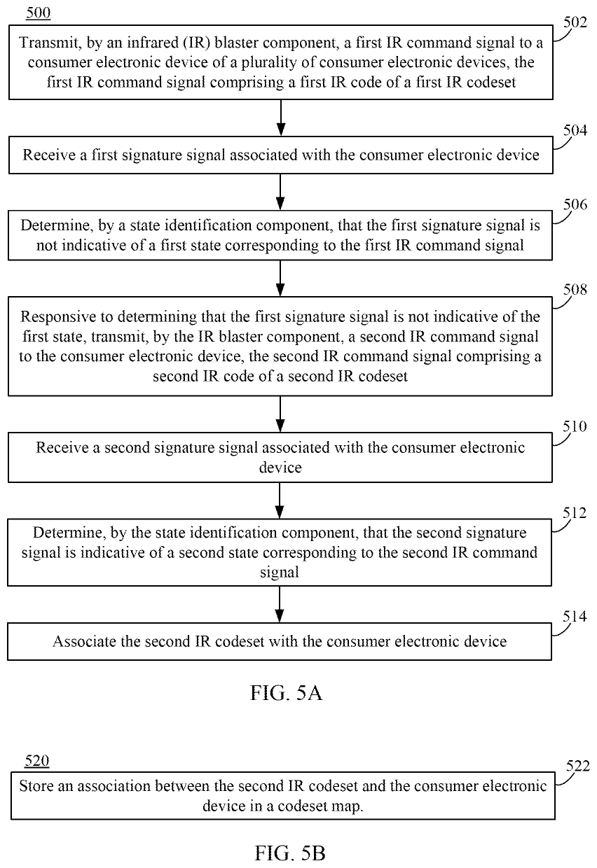

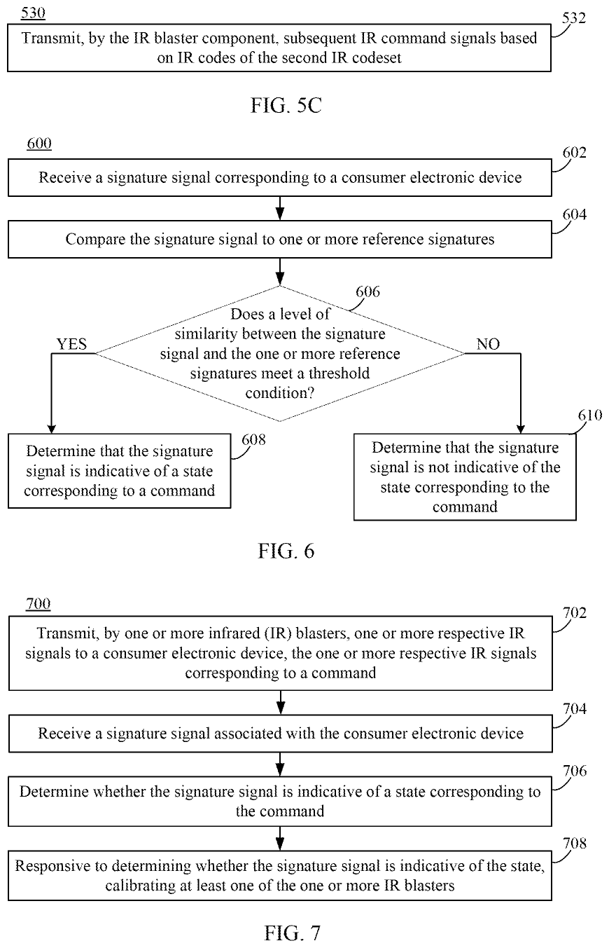

In embodiments, switching device 104B (or a component thereof) transmits commands to consumer electronic devices 102A-102D and/or speakers 108 as respective IR command signals 124 using IR blasters 144. Each IR command signal of IR command signals 124 comprises instructions to perform an action. Additional details regarding providing IR coverage using a switching device that comprises one or more IR blasters are discussed further with respect to FIGS. 2, 3, and 4. In another aspect, switching device 104A is configured to (e.g., automatically) select an IR codeset for controlling one or more of consumer electronic devices 102A-102D and/or speakers 108. Additional details regarding selecting an IR codeset are discussed further with respect to FIGS. 2 and 5A-5C. In another aspect, switching device 104A is configured to calibrate an IR blaster component of switching device 104A (e.g., based on transmitting a respective IR command signal of IR command signals 124 to one or more of consumer electronic devices 102A-102D and/or speakers 108, based on the location of switching device 104A (e.g., with respect to a consumer electronic device), based on an action associated with a respective IR command signal of IR command signals 124, based on previously transmitted IR command signals, and/or the like). Additional details regarding calibrating IR blaster components are discussed further with respect to FIGS. 2, 7 and 8.

Turning now to FIG. 2, an exemplary a block diagram of a media system 200 (“system 200” hereinafter) that includes a switching device 204 configured for providing IR coverage, selection, and/or calibration is shown in accordance with another exemplary embodiment. Switching device 204 is an example of switching device 104A, as described above with respect to FIG. 1A, and/or switching device 104B, as described above with respect to FIG. 1B. Switching device 204 may include and/or encompass the embodiments described herein. That is, switching device 204 of FIG. 2 is configured to perform methods and/or functions as described in embodiments using components and/or sub-components of the described embodiments. For instance, switching device 204 is configured to provide IR coverage in a media system, (e.g., automatically) select an IR code set for controlling one or more consumer electronic devices, and/or calibrate an IR blaster component of switching device 204, according to embodiments.

In embodiments, switching device 204 may include some or all of a transceiver 212, a first mapping component 214, a state identification component 216, control logic 218, one or more processors 220 (“processors 220” hereinafter), one or more storages 222 (“storage 222” hereinafter), a switching circuit 224, an identification component 226, an action determination component 228, a second mapping component 230, a control interface 232, ports 234, an IR calibration component 236, a signature calibration component 238, a network interface 240, a microphone 242, one or more IR blasters 244 (“IR blasters 244” hereinafter), and/or camera 250. Switching device 204 may be coupled to one or more source devices 202 (“source devices 202” hereinafter), one or more sink devices 206 (“sink devices 206” hereinafter), and/or one or more power monitors 210 (“power monitors 210” hereinafter) via connections 246 (e.g., HDMI connections, USB connections, etc.) as would be understood by persons of skill in the relevant art(s) having the benefit of this disclosure. Source devices 202 are examples of consumer electronic devices 102A-102C, sink devices 206 are examples of consumer electronic device 102D, and power monitors 210 are examples of power monitor 110, as respectively described above with reference to FIGS. 1A and 1B. System 200 also includes one or more speakers 208 (“speakers 208” hereinafter), which are examples of speakers 108, as respectively described above with reference to FIG. 2. As shown in FIG. 2, speakers 208 are coupled to sink devices 206. For instance, a respective speaker of speakers 208 may be coupled to a respective sink device of sink devices 206. Alternatively, multiple speakers of speakers 208 may be coupled to a single sink device of sink devices 206. In accordance with another alternative embodiment, a speaker (or group of speakers) of speakers 208 may be coupled to multiple sink devices of sink devices 206. Furthermore, any of speakers 208 and/or power monitors 210 may be incorporated in one or more of switching device 204, source devices 202, and/or sink devices 206.

Ports 234 may include one or more ports as described herein, although the embodiments described herein are not so limited. Ports 234 may be HDMI ports, USB ports, optical ports, network ports, and/or the like. Storage 222 may be one or more of any storage device described herein, such as, but not limited to, those described below with respect to FIG. 11. As shown in FIG. 2, storage 222 includes one or more signature files 248 (“signature files 248” hereinafter). Processors 220 may be one or more of any processing device or processor described herein, such as, but not limited to, those described below with respect to FIG. 11, and may be configured as described elsewhere herein. Transceiver 212 is configured to receive and transmit wired and/or wireless data according to any protocol and/or embodiment described herein, such as HDMI in HDMI switch embodiments. For instance, transceiver 212 is configured to receive and to transmit media content signals according to HDMI protocols from HDMI sources and to HDMI sinks respectively.

Identification component 226 may be implemented as hardware (e.g., electrical circuits), or hardware that executes one or both of software (e.g., as executed by a processor or processing device) and firmware. Identification component 226 is configured to operate and perform functions according to the embodiments described herein. For example, identification component 226 may be configured to identify the consumer electronic device (e.g., of source devices 202 or of sink devices 206) and/or power monitor (e.g., of power monitors 210) coupled to each port of ports 234. For example, for each device of source devices 202 and/or sink devices 206, identification component 226 may be configured to determine identifier(s) thereof, such as, but not limited to a type of the device (e.g., a DVD player, a Blu-ray player, a video game console, a streaming media device, a TV, an HDTV, a projector, etc.), a brand name of the device, a manufacturer of the device, a model number of the device, etc. Further, for each power monitor of power monitors 210, identification component 226 may be configured to determine identifier(s) thereof, such as, but not limited to a type of device, a brand name of the device, a manufacturer of the device, a model number of the device, an associated consumer electronic device (e.g., source device(s) 202 or sink device(s) 206), etc. The identifier(s) may be determined according to various techniques, such as, but not limited to: techniques based on HDMI consumer electronics control (CEC), identification via video data, identification via audio data, identification via IP network, remote control operation by a user, voice input from a user, and explicit device selection by a user. Identification component 226 outputs the identifier(s), which is/are received by first mapping component 214.

First mapping component 214 may be implemented as hardware (e.g., electrical circuits), or hardware that executes one or both of software (e.g., as executed by a processor or processing device) and firmware. First mapping component 214 is configured to operate and perform functions according to the embodiments described herein. First mapping component 214 is configured to determine a device-to-port mapping based on the identifier(s) received from identification component 226. For example, first mapping component 214 may generate a data structure (e.g., a table, a map, an array, etc.) that associates the identifier(s) for any given identified device to the port to which that electronic device is coupled. In this way, the device-to-port mapping may indicate that a first source device (e.g., a Blu-ray player) is coupled to a first port (e.g., Port 1), that a second source device (e.g., a set-top box) is coupled to a second port (e.g., Port 2), that a first sink device (e.g., a TV) is coupled to a third port (e.g., Port 3), and that a first power monitor is coupled to a fourth port (e.g., Port 4). Further, the data structure generated by first mapping component 214 may indicate which electronic device is associated with a power monitor. For example, the device-to-port mapping may indicate that the first sink device coupled to the third port is associated with (e.g., coupled to) the first power monitor coupled to the fourth port.

Control logic 218 receives the mapping generated by first mapping component 214 and optionally receives the identifiers generated by identification component 226. Based at least in part on the identifiers and mappings, control logic 218 is configured to generate a control signal that is received by switching circuit 224 and/or transceiver 212, and configured to cause switching circuit 224 to connect the identified source devices 202 and/or sink devices 206 on ports of ports 234 to corresponding receiver portions or transmitter portions of transceiver 212 and/or causing transceiver 212 to output desired media content signals received from source devices 202 on a specified output port of ports 234.

Switching circuit 224 may be implemented as hardware (e.g., electrical circuits), or hardware that executes one or both of software (e.g., as executed by a processor or processing device) and firmware. Switching circuit 224 is configured to operate and perform functions according to the embodiments described herein. For example, switching circuit 224 is configured to provide switched connections between ports 234 and transceiver 212. That is, switching circuit 224 may provide a connection between any port of ports 234 and any receiver component or transmitter component of transceiver 212. Switching circuit 224 may comprise one or more switch circuit portions (e.g., comprising one or more switches/switching elements) and may be combined or used in conjunction with other portions of system 200. Additional details regarding switching circuits and switching devices are described in U.S. patent application Ser. No. 14/945,175, entitled “Seamless Setup and Control for Home Entertainment Devices and Content,” which is incorporated by reference herein in its entirety. Control interface 232 may comprise a receiver configured to receive wireless control signals from a device, such as a remote control device (e.g., remote control device 106 of FIGS. 1A and 1B) and/or a computing device configured to control switching device 204, source device(s) 202, and/or sink device(s) 206. Control interface 232 may be configured to receive, detect, and/or sniff wireless control signals (e.g., IR control signals) from a plurality of different remote control devices, for example, a dedicated control device configured to control switching device 204, or dedicated control devices each configured to control a respective device of source device(s) 202 or sink device(s) 206. For instance, control interface 232 may comprise a wireless receiver configured to receive control signals transmitted from a remote control device via an IR-based protocol, an RF-based protocol, and/or an IP-based protocol. Upon detecting control signals, control interface 232 analyzes the control signals to identify one or more identifier(s) therein that uniquely identify the consumer electronic device for which the control signals are intended (e.g., source device(s) 202 and/or sink device(s) 206). Control interface 232 may further determine a command (e.g., a toggle power-on/power-off command, play, fast-forward, pause, rewind, etc.) included in the control signals. Control interface 232 may further determine a code (e.g., an IR code) of a codeset (e.g., an IR codeset) included in the control signals. The identifier(s), command(s), and/or code(s) may be provided to signature calibration component 238, state identification component 216, and/or IR calibration component 236, as described further below.

Network interface 240 is configured to interface with remote sites or one or more networks and/or devices via wired or wireless connections. Examples of networks include, but are not limited to, local area networks (LANs), wide area networks (WANs), the Internet, etc. Network interface 240 may be further configured to receive control signals over a network, determine commands included in such control signals, identify identifiers of consumer electronic device(s) for which the control signals are intended, and/or the like.

Microphone 242 is configured to detect, capture, and/or record audio signals. As shown in FIG. 2, microphone 242 is incorporated in switching device 204; however, the embodiments disclosed herein are not so limited. For instance, in accordance with one or more embodiments, microphone 242 may be external to switching device 204 and coupled to switching device 204 via a port of ports 234, control interface 232, and/or network interface 240. Alternatively, microphone 242 may be incorporated in one or more of source devices 202, sink devices 206, speakers 208, a remote control device, and/or the like. Microphone 242 is configured to detect, capture, and/or record audio signals. The captured and/or recorded audio signals are provided to signature calibration component 238 (e.g., for calibrating signature files based on the captured and/or recorded audio signals) and/or state identification component 216 (e.g., for determining a state of a consumer electronic device based on the captured and/or recorded audio signals), as described elsewhere herein.

Camera 250 is configured to capture videos or images. For instance, camera 250 in accordance with an embodiment is configured to capture videos or images of a sink device of sink devices 206 (e.g., a TV screen, a computer monitor, etc.). As shown in FIG. 2, camera 250 is incorporated in switching device 204; however, the embodiments disclosed herein are not so limited. For instance, in accordance with one or more embodiments, camera 250 is a camera device external to switching device 204 and coupled to switching device 204 via a port of ports 234, control interface 232, and/or network interface 240. Alternatively, camera 250 is incorporated in one or more of source devices 202, sink devices 206, speakers 208, a remote control device, and/or the like. Examples of camera 250 include, but are not limited to, a webcam, a security camera, a built-in camera, and/or the like. Camera 250 may include a microphone (e.g., microphone 242) incorporated therein. Camera 250 is configured to capture and/or record images and/or videos and generate a video signal. The video signal is provided to signature calibration component 238 (e.g., for calibrating signature files based on the generated video signal) and/or state identification component 216 (e.g., for determining a state of a consumer electronic device based on the generated video signal), as described elsewhere herein.

Signature calibration component 238 may be implemented as hardware (e.g., electrical circuits) and/or hardware that executes one or both of software (e.g., as executed by a processor or processing device) and firmware. Signature calibration component 238 is configured to operate and perform functions according to the embodiments described herein. For example, signature calibration component 238 may be configured to determine and store values for signatures, as described elsewhere herein. The values may be stored via one or more signature files 248. For instance, signature calibration component 238 may be configured to store signatures associated with states of sink device(s) 206 via signals received from power monitor(s) 210, audio signals captured via microphone 242, video signals and/or images captured via camera 250, signals received via control interface 232, network signals (e.g., network data packets) received via network interface 240, media content signals received from source devices 202, and/or the like. Signature calibration component 238 may calibrate signature files 248 for determining a state of a consumer electronic device responsive to a triggering event, on a periodic basis, responsive to receiving a calibration command (e.g., from control interface 232 or network interface 240), and/or the like. Signature calibration component 238 may perform various actions to calibrate signature files 248. For instance, signature calibration component 238 in accordance with an embodiment calibrates power signature files as described in U.S. patent application Ser. No. 17/934,312, entitled “STATE DETECTION VIA POWER MONITORING,” which is incorporated by reference herein in its entirety. In accordance with another embodiment, signature calibration component 238 uses calibration techniques to calibrate other signature files (e.g., signature files that correspond to video signals, media content signals, images, and/or network signals, and/or other signature signals suitable for determining the state of a consumer electronic device, as would be understood by a person ordinarily skilled in the relevant art(s) having benefit of this disclosure). Such techniques may include, for example, issuing commands to be transmitted to one or more consumer electronic devices, subsequently receiving a signature signal, analyzing the signature signal, and generating a signature file based on the issued command and/or analyzed signature signal.

As part of the calibration process, signature signals are provided to signature calibration component 238. Signature calibration component 238 is configured to store the signature signals as reference signatures associated with the corresponding consumer electronic device operating in a corresponding state. The reference signatures may be stored as one or more of signature file(s) 248. Reference signatures may be stored as a dataset (e.g., a graph, a table, an array, etc.). Signature file(s) 248 may be used by state identification component 216.

State identification component 216 may be implemented as hardware (e.g., electrical circuits), or hardware that executes one or both of software (e.g., as executed by a processor or processing device) and firmware. State identification component 216 is configured to operate and perform functions according to the embodiments described herein. For example, state identification component 216 may be configured to determine a state with respect to consumer electronic device(s) communicatively coupled to switching device 204. For instance, in embodiments, state identification component 216 may be configured to determine a state of sink devices 206 and/or source devices 202 via one or more of signals received from power monitors 210, audio signals captured by microphone 242, video signals and/or images captured by camera 250, signals received via control interface 232 (e.g., from a remote control device and/or other device of system 200), signals received via network interface 240, and/or the like. Additional details regarding determining the state of a consumer electronic device are described with respect to FIG. 6.

Signature signals may be provided to signature calibration component 238 and/or state identification component in various ways, in embodiments. For instance, in one aspect, power monitors 210 are configured to provide respective power signature signals. For instance, power monitors 210 may receive one or more power signals from corresponding sink devices 206 (and/or source devices 202) and provide one or more corresponding power signature signals to switching device 204 (e.g., via a port of ports 234 to which the power monitor of power monitors 210 is coupled, via control interface 232 to which the power monitor of power monitors 210 is coupled, or via network interface 240 to which the power monitor of power monitors 210 is coupled). Power monitors 210 may function in a similar manner as the power monitors described in U.S. patent application Ser. No. 17/934,312, entitled “STATE DETECTION VIA POWER MONITORING.”

In another aspect, audio signature signals are captured by microphone 242, an external microphone coupled to switching device 204 (e.g., via a port of ports 234, control interface 232, and/or network interface 240), a microphone incorporated in a remote control device, and/or a microphone incorporated in a consumer electronic device. The audio signature signals are provided to one or more of state identification component 216 and/or signature calibration component 238. Such audio signature signals may be captured in a similar manner to the audio signals captured by the microphones described in U.S. patent application Ser. No. 17/935,650, entitled “POWER STATE DETECTION VIA AUDIO SIGNAL CAPTURE,” which is incorporated by reference herein in its entirety. For instance, the captured audio signature signal represents audio played back via speakers 208. The captured audio signature signals are provided to state identification component 216 and/or signature calibration component 238 for cross correlation analysis with respect to audio files (e.g., audio signature files of signature files 248).

In another aspect, video signature signals (e.g., also referred to as video signals) are captured by camera 250, an external camera coupled to switching device 204 (e.g., via a port of ports 234, control interface 232, and/or network interface 240), a camera incorporated in a remote control device, and/or a camera incorporated in a consumer electronic device. The video signature signals are provided to one or more of state identification component 216 and/or signature calibration component 238.

In an alternative aspect, video signature signals are received from a consumer electronic device over a connection with switching device 204 (e.g., by a port of ports 234, over control interface 232, over network interface 240, etc.). In this alternative, the video signature signals may be included in media content signals transmitted from a source device of source devices 206, may be included in media content signals transmitted to a sink device of sink devices 206, may be included in signals transmitted by a sink device that is playing back video content, and/or the like. Examples of receiving video signature signals and determining states based on the received video signature signals are discussed further with respect to “identification information” and “video attributes” in U.S. patent application Ser. No. 16/250,808, entitled “Device Identification and Power State Determination Using Media Device Information,” which is incorporated by reference herein in its entirety. Similar techniques may be used to identify audio attributes, device addresses, and/or any other attributes discussed in U.S. patent application Ser. No. 16/250,808 that would be suitable for determining the state of a consumer electronic device.

Action determination component 228 may be implemented as hardware (e.g., electrical circuits), or hardware that executes one or both of software (e.g., as executed by a processor or processing device) and firmware. Action determination component 228 is configured to operate and perform functions according to the embodiments described herein. For example, action determination component 228 may be configured to, based on the state, perform at least one action with respect to a particular consumer electronic device. For example, and without limitation, action determination component 228 may issue a toggle command to source devices 202, sink devices 206, and/or speakers 208 to toggle power (i.e., to turn it off or on), issue an operational command to source devices 202, sink devices 206, and/or speakers 208, such as “play” or “pause”, transmit a notification message to source devices 202, sink devices 206, and/or speakers 208, and/or automatically cause switching device 204 to switch to port(s) of ports 234 to which a particular source device of source devices 202, a particular sink device of sink devices 206, and/or a particular speaker of speakers 208 are connected. In one aspect, action determination component 228 issues commands to source devices 202 and/or sink devices 206 using IR blasters 244. Action determination component 228 may determine the action(s) to be performed using second mapping component 230.

Second mapping component 230 may be implemented as hardware (e.g., electrical circuits), or hardware that executes one or both of software (e.g., as executed by a processor or processing device) and firmware. Second mapping component 230 is configured to operate and perform functions according to the embodiments described herein. Second mapping component 230 is configured to maintain a state-to-action mapping that specifies action(s) that are to be performed by switching device 204 based on the state for a particular device. Second mapping component 230 may maintain a state-to-action mapping for each of source devices 202, sink devices 206, and/or speakers 208. Each state-to-action mapping may comprise a data structure (e.g., a table) that associates the action(s) to take for any given state. Action determination component 228 may reference second mapping component 230 to determine the action(s) to be performed in response to detecting a triggering event. In accordance with an example embodiment, action determination component 228 may reference second mapping component 230 to determine the action(s) to be performed as part of the calibration process as described with respect to signature calibration component 238 above.

IR blasters 244 are further examples of IR blasters 144, as described above with respect to FIG. 1B. IR blasters 244 comprises one or more IR blasters (also referred to as “IR blaster components” herein) configured to project IR light. In accordance with one or more embodiments, and as discussed with respect to FIGS. 3 and 4 below, different IR blasters of IR blasters 244 are oriented in a manner to project IR light in different directions. In this context, the IR light from two or more IR blasters may or may not overlap. IR blasters 244 may project a light in a linear, conical, or other manner, as would be understood by one ordinarily skilled in the relevant art(s) having benefit of this disclosure. In accordance with an embodiment, IR blasters 244 are IR light-emitting diodes (LEDs); however, embodiments disclosed herein are not so limited. As shown in FIG. 2, IR blasters 244 are incorporated in switching device 204; however, it is also contemplated herein that IR blasters 244 may include one or more external IR blasters coupled to switching device 204 (e.g., via port(s) of ports 234, control interface 232, or network interface 240). In embodiments, switching device 204 (or a component thereof) transmits commands to consumer electronic devices (e.g., source devices 202, sink devices 206, and/or speakers 208) as IR command signals using IR blasters 244. IR blasters 244 may transmit IR command signals by emitting IR light according to an IR code of an IR codeset. In embodiments, the IR codeset may be a codeset associated with a consumer electronic device that the IR command signal is attended for. Switching device 204 (or a component thereof) may be configured to (e.g., automatically) select an IR codeset to use for transmitting IR command signals to a particular consumer electronic device. Additional details regarding IR codeset determination and selection are described further with respect to FIGS. 5A-5C.

In accordance with one or more embodiments, switching device 204 (or a component thereof) adjusts a magnitude of current used by an IR blaster of IR blasters 244 (e.g., based on a calibration of the IR blaster by IR calibration 236, based on an action determined by action determination component 228, based on a state determined by state identification component 216, etc.), as described elsewhere herein. For instance, in accordance with an example embodiment, a magnitude of current of one or more IR blasters of IR blasters 244 is configured to project IR light in a manner that enables the projected IR light to reflect off of a surface (e.g., a wall, furniture (e.g., an entertainment system, a desk, an end table, etc.), a surface of a consumer electronic device, and/or the like) with enough light intensity to be pass a received IR light threshold of an IR receiver of a consumer electronic device. Additional details regarding IR coverage using IR blasters are discussed with respect to FIGS. 3 and 4.

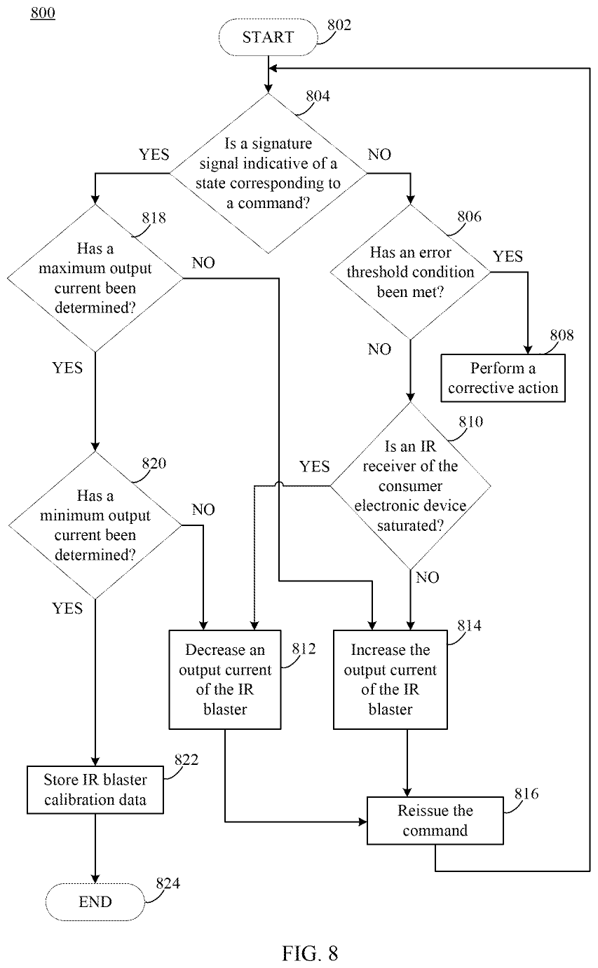

IR calibration component 236 may be implemented as hardware (e.g., electrical circuits) and/or hardware that executes one or both of software (e.g., as executed by a processor or processing device) and firmware. IR calibration component 236 is configured to calibrate one or more IR blasters of IR blasters 244 according to the embodiments described herein. For example, IR calibration component 236 may be configured to determine a magnitude of current for an IR blaster of IR blasters 244 to emit IR light. IR calibration component 236 may determine a magnitude of current for all of IR blasters 244, a subset of IR blasters 244, and/or an individual IR blaster of IR blasters 244. In accordance with an embodiment, IR calibration component 236 calibrates one or more IR blasters of IR blasters 244 based at least on one or more of: an action to be performed by a consumer electronic device, a consumer electronic device for which an IR command signal is intended, a location of switching device 204, a location and/or orientation of the IR blaster, the ambient light of a room switching device 204 is located in, and/or the like, as described elsewhere herein. Additional details regarding the calibration of IR blasters are discussed with respect to FIGS. 7 and 8.

### III. Example IR Coverage Embodiments

As discussed above, methods, systems, switching devices, consumer electronic devices, and/or computer storage mediums described herein may provide IR coverage in a media system in various ways, in embodiments. For example, FIG. 3 is a flowchart 300 of a process for providing IR coverage in a media system, according to an exemplary embodiment. Switching device 204 of FIG. 2 may operate according to flowchart 300 in embodiments. Not all steps of flowchart 300 need be performed in all embodiments. Further structural and operational embodiments will be apparent to persons skilled in the relevant art(s) based on the following description of FIG. 3 with respect to FIG. 2.

Flowchart 300 begins with step 302. In step 302, a triggering event is detected. For instance, switching device 204 (or a component thereof) of FIG. 2 detects a triggering event. Examples of triggering events include, but are not limited to, receiving a command via control interface 232 and/or network interface 240, detecting a wireless control signal (e.g., sent from a remote control device) by control interface 232, detecting a change in state of a consumer electronic device (e.g., by state identification component 216), and/or any other event that, when detected, would cause switching device 204 to determine an action to be performed by a consumer electronic device, as described herein. For instance, in a first non-limiting example (“Example 1”), switching device 204 (or a component thereof) may determine that a user has performed an action intended to cause any or all of source devices 202, sink devices 206, and/or speakers 208 to perform an action (e.g., transition to a desired state, launch media content, open an interface, and/or the like). One such action may be providing a command (e.g., via interacting with a particular interface element (e.g., a button or selectable icon) (or the like) of a remote control device or via a voice command) that is configured to power on or off particular source devices 202, sink devices 206, and/or speakers 208. For instance, a user may interact with a “Watch DVD” interface element on a remote control device or speak the words “Watch DVD” in microphone 242 and/or a microphone included in a remote control device (not shown). In this context, control interface 232 may detect the user-directed command and provide the detected command to state identification component 216 for determining states of corresponding consumer electronic device(s) coupled to switching device 204. Furthermore, state identification component 216 may provide the determined states to action determination component 228 and flowchart 300 continues to step 304.

In a second non-limiting example (“Example 2”), a triggering event is receiving a command via network interface 240. For instance, suppose a first user remotely-located from system 200 (e.g., in another house, building, etc.) would send a notification (e.g., an emergency notification (“Severe Thunderstorm Warning,” “There's a fire in the building, evacuate immediately,” etc.), a notification to provide a reminder, a notification to initiate a video call, etc.) to be displayed on a TV of sink devices 206 with the intent of a second user of the TV reading the notification. Network interface 240 provides the received commands to state identification component 216 for determination of the state of the TV. For instance, suppose state identification component 216 determines that the TV is in a powered off state. In this context, state identification component 216 provides the determined state of the TV to action determination component 228 and flowchart 300 continues to step 304.

In a third non-limiting example (“Example 3”), a triggering event is determining that an action was performed incorrectly. For instance, state identification component 216 may determine a TV of sink device(s) 206 is not in an expected state (e.g., powered on) based on a previous command transmitted to the consumer electronic device. In this context, state identification component 216 provides an indication of the error and the current determined state to action determination component 228 and flowchart 300 continues to step 304.

In a fourth non-limiting example (“Example 4”), a triggering event is detecting a change in state of a consumer electronic device. State identification component 216 may (e.g., automatically) detect changes in state based on, for example, signals received via a port of ports 234, control interface 232, network 240, microphone 242, and/or camera 250. For instance, suppose state identification component 216 receives a power signature signal from a power monitor of power monitors 210 corresponding to a power signal of a video game console of source devices 202 and determines, based at least on the power signature signal, that a state of the video game console changed from a powered off state to a powered on state. In this context, state identification component 216 provides the determined current state and the indication of the change to action determination component 228 and flowchart 300 continues to step 304.

In step 304, responsive to detecting the triggering event, an action to be performed by a first consumer electronic device is determined. For instance, action determination component 228 of FIG. 2 determines an action to be performed by a consumer electronic device in response to the trigger event detected in step 302. For example, action determination component 228 may determine the consumer electronic device is to perform a toggle power action (e.g., turn on or off), launch media content, perform an operational operation (e.g., “play” or “pause”), open a menu, display a notification, and/or the like. Action determination component 228 may determine the action(s) to be performed based on one or more of, the detected triggering event, state(s) determined by state identification component 216, referencing second mapping component 230, referencing first mapping component 214, identifier(s) of consumer electronic devices (e.g., source device(s) 202, sink device(s) 206, and/or speaker(s) 208), and/or the like.

For instance, continuing with reference to Example 1, suppose state identification component 216 determined that a DVD player source device of source devices 202 was in a powered on standby state and a TV sink device of sink devices 206 was in a powered on state. In this context, action determination component 228 may determine if the ports of ports 234 to which the DVD player source device and the TV sink device are coupled to are connected (e.g., by referencing first mapping component 214). If the ports are not connected, action determination component 228 issues a command to switching circuit 224 to couple the ports. Furthermore, based on the identified states and by referencing second mapping component 230, action determination component 228 determines that the TV sink device is to remain in the powered on state and that the DVD player source device is to perform a “play” action, and flowchart 300 continues to step 306.

Turning now to Example 2, action determination component 228 determines (e.g., based on the state determined by state identification component 216 and by referencing second mapping component 230) that the TV is to display the notification. Furthermore, action determination component 228 may determine whether or not the notification is to be displayed on the TV using an interface of the TV or using media content signals generated by a source device coupled to switching device 204 (e.g., a streaming media player or other source device). If an interface of the TV is to be used, action determination component 228 determines that the TV is to perform an action to display the notification. If media content signals generated by a source device are to be used, action determination component 228 determines if the ports of the source device and the TV are connected, issues a command to switching circuit 224 to connect the ports (if applicable), determines the source device is to perform a power on action (e.g., if the source device is not in a powered on state), and determines the source device is to generate media content signals including the notification. In either case, flowchart 300 continues to step 306.

Turning now to Example 3, action determination component 228 determines (e.g., based on the indicated error, the current determined state, and by referencing second mapping component 230) that a corrective action is to be performed, the corrective action including an action to be performed by the TV. For instance, action determination component 228 may determine that the previously issued command is to be reissued and the TV is to perform an action instructed by the command, and flowchart 300 continues to step 306. Additional details regarding corrective actions are discussed with respect to FIG. 8.

Turning now to Example 4, action determination component 228 determines (e.g., based on the determined state of the video game console, the indication of the change, and referencing second mapping component 230) that a TV of sink devices 206 is to be powered on and corresponding ports of the TV and video game console are to be connected. In one aspect, action determination component 228 may issue a request to state identification component 216 to determine a current state of the TV and subsequently determine an action to be performed by the TV based on the determination. For instance, suppose state identification component 216 determines that the TV is in a powered off state. In this context, action determination component 228 determines that a toggle power action is to be performed by the TV, and flowchart 300 continues to step 306.

In step 306, a determination that the first consumer electronic device is controllable using IR signals is made. For instance, action determination component 228 of FIG. 2 is configured to determine whether or not the consumer electronic device is controllable using IR signals. For instance, action determination component 228 may reference data structures generated by identification component 226 and/or first mapping component 214 to determine whether or not the consumer electronic device is controllable using IR signals. If the consumer electronic device is controllable using IR signals, flowchart 300 continues to step 308. Otherwise, action determination component 228 issues commands to the consumer electronic device through other means (e.g., using RF command signals, network command signals, signals over corresponding ports of ports 234, etc.). Non-limiting examples of these other means are described, for example, in U.S. patent application Ser. No. 17/934,312, entitled “STATE DETECTION VIA POWER MONITORING.”

In step 308, an IR command signal is transmitted to the first consumer electronic device by a plurality of IR blaster components. The IR command signal comprises instructions to perform the determined action. For instance, each of IR blasters 244 may transmit the same IR command signal to the first consumer electronic device simultaneously. The IR command signal comprises instructions to perform the action determined in step 304. For instance, with reference to Example 1, IR blasters 244 transmit an IR command signal to the DVD player source device. In this context, the IR command signal comprises instructions to perform a “play” action. With reference to Example 2, IR blasters 244 transmit an IR command signal to the TV, the IR command signal comprising instructions to display the notification. Alternatively, IR blasters 244 transmit an IR command signal to the source device, the IR command signal comprising instructions to generate media content signals including the notification. With reference to Example 3, IR blasters 244 transmit an IR command signal to the TV, the IR command signal comprising instructions to perform the action associated with the corrective action. With reference to Example 4, IR blasters transmit an IR command signal to the TV, the IR command signal comprising instructions to perform a toggle power action (e.g., to turn on the TV).

In embodiments, the IR command signal includes one or more corresponding IR codes of an IR codeset that corresponds to the receiving consumer electronic device. In accordance with an embodiment, the IR command signal is sent using multiple signals (e.g., respective signals from IR blasters of IR blasters 244, a sequence of signals from one or more IR blasters of IR blasters 244, etc.). For instance, an IR command signal may include multiple commands, each transmitted in a separate sub-signal of the IR command signal.

Switching devices may provide IR coverage in various applications. For instance, switching device 204 of FIG. 2 may be implemented in a media system (e.g., an entertainment system) that includes one or more consumer electronic devices controllable using IR signals. As described above, IR blasters of switching device 204 may be oriented to project IR light in different directions, thereby enabling switching device 204 to transmit IR command signals to consumer electronic devices in various locations. Furthermore, depending on the physical placement of switching device 204 and the consumer electronic device(s), IR receiver(s) of the consumer electronic device(s) may be obstructed from the line of sight of the IR blasters of switching device 204. In this context, a magnitude of current of one or more IR blasters of switching device 204 may be configured to project IR light in a manner that enables the projected IR light to reflect off of a surface with enough light intensity to pass a received IR light threshold of an IR receiver of a consumer electronic device.

Turning now to FIG. 4, an example implementation of a switching device 404 that provides IR coverage for a media system 418 (“system 418” hereinafter) in a room 400 (“room 400” hereinafter) is shown. As shown in FIG. 4, room 400 includes media system 416 and walls 406A-406B. Room 400 may include additional systems (e.g., computer systems, network systems, additional media systems, etc.), furniture (e.g., couches, chairs, tables, end tables, coffee tables, entertainment centers, stools, etc.), walls, doors, and/or systems, devices, structures, and/or the like (not shown). As also shown in FIG. 4, system 418 includes a TV 402 and switching device 404. TV 402 is an example of consumer electronic device 102D and sink devices 206, as respectively described above with respect to FIGS. 1 and 2. Switching device 404 is an example of switching device 104A, as described above with respect to FIG. 1A, switching device 104B, as described above with respect to FIG. 1B, and/or switching device 204, as described above with respect to FIG. 2. System 418 may include additional consumer electronic devices (e.g., source devices, other sink devices, speakers, etc.) and/or remote control devices (not shown), each of which may be coupled to switching device 404 by respective connections.

Switching device 404 may include and/or encompass the embodiments described herein. That is, switching device 404 of FIG. 4 is configured to perform methods and/or functions as described in embodiments using components and/or sub-components of the described embodiments. For instance, switching device 404 is configured to provide IR coverage in system 400, according to embodiments. As shown in FIG. 4, switching device 404 includes IR blasters 444A-444E, which are examples of IR blasters 244, as described above with respect to FIG. 2. Switching device 404 may include additional components similar to those described above with respect to switching device 204 of FIG. 2, not shown in FIG. 4 for brevity. Switching device 404 is coupled to TV 402 via connection 210 (e.g., an HDMI connection, etc.) as would be understood by persons of skill in the relevant art(s) having the benefit of this disclosure.

TV 402 is a TV sink device that is controllable using IR command signals. As shown in FIG. 4, TV 402 includes an IR receiver 416. IR receiver 416 may be positioned anywhere on TV 402 (e.g., on the front of TV 402) in a manner that facilitates reception of IR signals (e.g., from a remote control device and/or switching device 404). IR receiver 416 includes an IR sensor and associated circuits that interpret IR signals sensed by the IR sensor, as would be understood by persons of skill in the relevant art(s) having benefit of this disclosure. For instance, IR receiver 416 may be configured with a predetermined “received IR light threshold” that specifies the minimum amount/intensity of IR light sensed by the IR sensor of IR receiver 416 for IR receiver 416 to detect the corresponding IR command signal. For example, the received IR light threshold may be set at a predetermined level to prevent IR receiver 314 from interpreting noise and/or non-IR command signal IR light as IR command signals. Furthermore, the IR sensor of IR receiver 416 may have a saturation point, wherein the IR sensor has received too much IR light (e.g., by receiving IR light with an intensity above a saturation level or by receiving a number of subsequent IR signals within a window of time that would saturate the IR sensor). IR receiver 416 may also be programmed with a timeout window, wherein the circuits of the IR receiver 416 do not respond to IR signals received by the IR sensor of IR receiver 314 after a first IR signal is detected. This timeout window prevents IR receiver 416 from (e.g., erroneously) interpreting a single IR command signal as multiple IR command signals.

As shown in FIG. 4, IR blasters 444A-444E project respective IR light 412A-412E. In accordance with an embodiment, IR light signals 412A-412E correspond to an IR command signal transmitted by switching device 404. For instance, IR light signals 412A-412E correspond to IR codes of an IR codeset associated with TV 402. Each of IR light signals 412A-412E may be the same IR light signal, but transmitted from a different IR blaster of IR blasters 444A-444E. Each of IR blasters 444A-444E may transmit a respective IR light signal simultaneously. As shown in FIG. 4, IR blaster 444A is oriented in a manner that enables IR receiver 416 of TV 402 to receive IR light signal 412A projected by IR blaster 444A. Furthermore, IR blasters 444A-444E may be configured to project respective IR light signals 412A-412E at a magnitude that enables IR light signals 412A-412E to reflect off of a surface (e.g., walls 406A-406B). For instance, IR blasters 444B and 444C project IR light signals 412B and 412C, respectively, which reflect off of wall 406B as reflected light signals 414B and 414C, respectively. For instance, IR blaster 444B is oriented in a manner that enables IR receiver 416 to receive reflected IR light signal 414B reflected off wall 406B.

By having IR blasters oriented in different directions and/or enabling IR blasters 444A-444E to project IR light signals 412A-412E at magnitudes that enable the IR light signals to be reflected at an appropriate intensity for detection by an IR receiver, switching device 404 increases the IR coverage provided by switching device 404. This thereby enables switching device 404 to transmit IR command signals to consumer electronic devices (such as TV 402) that may be positioned in different locations throughout room 400. For instance, suppose an obstacle (e.g., furniture, a surface of another consumer electronic device, or another object) obscured the line of sight between IR blaster 444A and IR receiver 416. In this context, IR command signals (e.g., as IR light signal 412A) transmitted by IR blaster 444A are unable to reach IR receiver 416. However, IR command signals (e.g., as IR light signal 412A) transmitted by IR blaster 444B are transmitted at a magnitude that enables the IR command signals to be reflected off wall 406B (e.g., as reflected light signal 414B) with enough intensity to reach (or surpass) a received IR light threshold of IR receiver 416.

While switching device 404 is depicted in FIG. 4 with five IR blasters 444A-444E, embodiments disclosed herein may include fewer than five (e.g., one, two, three, or four), five, or greater than five (e.g., six, seven, eight, nine, tens, or even greater) IR blasters. Furthermore, while IR blasters 444A-444E are, as illustrated in FIG. 4, oriented in their respective directions, IR blasters in accordance with one or more embodiments may be oriented in any direction (e.g., above switching device 404, at a vertical and/or horizontal angle away from switching device 404, below switching device 404, behind switching device 404, etc.) to project IR light. Moreover, while IR light signals 412A-412E are depicted as linear light signals projected from respective IR blasters 444A-444E; embodiments disclosed herein are not so limited. For instance, in accordance with an embodiment, one or more of IR blasters 444A-444E may be configured to project IR light signals in a conical shape. Furthermore, IR light signals projected from two or more IR blasters may overlap.

### IV. Example IR Codeset Selection Embodiments

As discussed above, methods, systems, switching devices, consumer electronic devices, and/or consumer electronic devices may (e.g., automatically) select an IR codeset to control a consumer electronic device in a media system. For instance, suppose switching device 204 of FIG. 2 or a user associated therewith does not know the IR codeset that corresponds to a particular consumer electronic device (e.g., one or more of source devices 202, sink devices 206, and/or speakers 208) in system 200. In this context, switching device 204 may be configured to automatically determine the IR codeset that corresponds to the particular electronic device through a trial-and-error selection process.

The IR codeset selection process may be performed in various ways, in embodiments. For example, FIG. 5A is a flowchart 500 of a process for automatic selection of an IR codeset to control a consumer electronic device, according to an exemplary embodiment. Switching device 204 of FIG. 2 may operate according to flowchart 500 in embodiments. Not all steps of flowchart 500 need be performed in all embodiments. Further structural and operational embodiments will be apparent to persons skilled in the relevant art(s) based on the following description of FIG. 5A with respect to FIG. 2.

Flowchart 500 begins with step 502. In step 502, a first IR command signal is transmitted by an IR blaster component to a consumer electronic device of a plurality of consumer electronic devices. The first IR command signal comprises a first IR code of a first IR codeset. For example, one or more of IR blasters 244 of FIG. 2 transmits a first IR command signal to a consumer electronic device among source devices 202, sink devices 206, and speakers 208, the first IR command signal comprises a first IR code of a first codeset. The first codeset may be a randomly selected codeset, a codeset selected from a list of IR codesets, a codeset selected by IR calibration component 236, and/or the like. The IR codeset may be from a set of IR codesets stored in storage 222, from a set of IR codesets remotely accessible via network interface 240, and/or the like. The IR codeset may be selected based on identifier(s) associated with the consumer electronic device. For instance, if the consumer electronic device is a particular brand, the IR codeset may be selected from among IR codesets used by that brand. The first IR command signal may be a command to enter a particular state (e.g., an on or off state), a command to display a particular menu, and/or the like. In accordance with an embodiment, the first IR command signal is based on the current state of the consumer electronic device, as determined by state identification component 216. For instance, suppose state identification component 216 determines a TV of sink devices 206 is in a powered off state and switching device 204 is determining which IR codeset is used to control the TV. In this context, IR blasters 244 transmit a first IR command signal to the TV, the first IR command signal including a “toggle power” IR code of a first IR codeset.

In step 504, a first signature signal associated with the consumer electronic device is received. For example, switching device 204 of FIG. 2 (or a component thereof) receives a first signature associated with the consumer electronic device. Example signature signals include, but are not limited to, power signature signals received from power monitors 210 via ports 234, wireless signature signals (e.g., IR signals, RF signals, etc.) received, sniffed, and/or detected by control interface 232, network signals received by network interface 240, audio signature signals captured and/or recorded by microphone 242, audio signature signals captured and/or recorded by a microphone of a remote control device and received via control interface 232, video and/or image signature signals generated by camera 250, and/or any other signature signal described herein.

In step 506, a determination that the first signature signal is not indicative of a first state corresponding to the first IR command signal is made by a state identification component. For example, state identification component 216 of FIG. 2 determines that the first signature signal received in step 504 is not indicative of a first state corresponding to the first IR command signal transmitted in step 502. For instance, the consumer electronic device may have not changed states (e.g., the TV in the above-mentioned example remained in a powered off state) or changed states to the wrong state (e.g., a DVD player began playing a DVD rather than opening a user interface). In accordance with an embodiment, state identification component 216 makes the determination by performing a cross correlation of the first signature signal and a reference signature (e.g., a signature file of signature files 248, a transmitted reference signature, and/or the like) associated with the first state. In embodiments, IR calibration component 236 may store (e.g., temporarily) an indication of that the first IR codeset is not a suitable codeset for controlling the consumer electronic device. Additional details regarding the determination of the state of a consumer electronic device are discussed with respect to FIG. 6.

In step 508, responsive to the determination that the first signature signal is not indicative of the first state, a second IR command signal is transmitted by an IR blaster component to the consumer electronic device. The second IR command signal comprises a second IR code of a second IR codeset. For instance, IR blasters 244 of FIG. 2 transmit a second IR command signal to the consumer electronic device, the second IR command signal comprising a second IR code of a second IR codeset. The second IR codeset may be selected in a similar manner as the first IR codeset. The second IR code may be an IR code that corresponds to a command similar to the first IR code (e.g., an IR code keyed to the same state as the first IR code). For instance, if the first IR code was an IR code corresponding to a toggle power action of a TV and the TV remains in a powered off state, the second IR code may also be an IR code (of a different codeset) corresponding to a toggle power action of the TV. Alternatively, the first IR code and the second IR code correspond to different commands (i.e., are keyed to different states).

In step 510, a second signature signal associated with the consumer electronic device is received. For example, switching device 204 of FIG. 2 (or a component thereof) receives a second signature signal associated with the consumer electronic device. The second signature signal may be received in a similar manner as the first signature signal, as described with respect to step 504 above. The second signature signal may be the same type of signature signal as the first signature signal or a different type of signature signal, in embodiments.

In step 512, a determination that the second signature signal is indicative of a second state corresponding to the second IR command signal is made by the state identification component. For instance, state identification component 216 of FIG. 2 determines that the second signature signal received in step 510 is indicative of a second state corresponding to the second IR command signal transmitted in step 508. State identification component 216 may make this determination in a similar manner as described above with respect to step 506. Additional details regarding the determination of the state of a consumer electronic device are discussed with respect to FIG. 6.

In step 514, the second IR codeset is associated with the consumer electronic device. For example, IR calibration component 236 of FIG. 2 associates the second IR codeset with the consumer electronic device. In this manner, switching device 204 (or a component thereof) is able to determine IR codes that correspond to actions that action determination component 228 determines for the consumer electronic device to perform. In embodiments, this association may be stored (e.g., in storage 222, in a remotely accessible storage, etc.) for future use. In accordance with an embodiment, IR calibration component 236 associates the determined codeset with one or more identifiers of the consumer electronic device.

While flowchart 500 has been described with respect to determining that a first codeset is not suitable for controlling a consumer electronic device and determining that a second codeset is suitable for controlling a consumer electronic device, it is contemplated herein that the process of transmitting command signals including IR codes of respective IR codesets may be repeated any number of times to determine the correct codeset. For instance, switching device 204 may determine that a first IR codeset is suitable for controlling a consumer electronic device. Alternatively, switching device 204 may try transmitting more than two IR command signals, each including an IR code of a respective IR codeset, before determining the correct IR codeset that is suitable for controlling the consumer electronic device.

Step 514 of flowchart 500 may be performed in various ways, in embodiments. For instance, FIG. 5B is a flowchart 520 of a process for associating an IR codeset with a consumer electronic device, according to an exemplary embodiment. Switching device 204 of FIG. 2 may operate according to flowchart 520 in embodiments. Flowchart 520 need not be performed in all embodiments. Further structural and operational embodiments will be apparent to persons skilled in the relevant art(s) based on the following description of FIG. 5B with respect to FIG. 2.

Flowchart 520 includes step 522. In step 522, an association between the second IR codeset and the consumer electronic device is stored in a codeset map. For example, IR calibration component 236 of FIG. 2 in accordance with an embodiment stores an association between the second IR codeset and the consumer electronic device in a codeset map. The codeset map may be generated by IR calibration component 236, be generated by another component of switching device 204, be a pre-existing map, and/or the like. The codeset map may include information such as, but not limited to, identifier(s) of consumer electronic devices, the corresponding IR codeset suitable for controlling the respective consumer electronic devices, a port of ports 234 to which the consumer electronic device is coupled to, and/or the like.

After associating the second IR codeset with the consumer electronic device, the association between the second IR codeset and the consumer electronic device may be referenced for performing other actions with respect to the consumer electronic device, in embodiments. For instance, FIG. 5C is a flowchart 530 of a process for utilizing an associated IR codeset with respect to a consumer electronic device, according to an exemplary embodiment. Switching device 204 of FIG. 2 may operate according to flowchart 530 in embodiments. Flowchart 530 need not be performed in all embodiments. Further structural and operational embodiments will be apparent to persons skilled in the relevant art(s) based on the following description of FIG. 5C with respect to FIG. 2. Flowchart 530 includes step 532. In step 532, subsequent IR command signals are transmitted by the IR blaster component based on IR codes of the second IR codeset. For example, IR blasters 244 transmit IR command signals to the consumer electronic device based on IR codes of the second IR codeset. For instance, action determination component 228 may determine the IR code of the associated IR codeset that corresponds to an action (e.g., an action determined in step 304 of FIG. 3) that a consumer electronic device is to perform. In this context, an IR command is generated according to the determined IR code, and IR blasters 244 transmit an IR command signal including the determined IR code. Alternatively, IR blasters 244 include additional control circuits or firmware (not shown in FIG. 2) that determines IR codes based on actions determined by action determination component 228 and the IR codeset associated with the consumer electronic device. In embodiments, action determination component 228 and/or IR blasters 244 determine the IR code by referencing a codeset map, as described elsewhere herein.

### V. Example State Determination Embodiments

As discussed above, methods, systems, switching devices, consumer electronic devices, and/or consumer electronic devices may be configured to determine the state of a consumer electronic device. Embodiments may determine the state of the consumer electronic device, for example, to determine an action to be performed by the consumer electronic device, to determine an action to be performed by another consumer electronic device, to determine whether or not to switch connections between ports of ports 234, to confirm whether or not a consumer electronic device entered the correct state subsequent to the transmission of a command signal, and/or to perform other operations and/or functions described herein. Example states include, but are not limited to, powered off, standby (e.g., a low power state with one or more sub-systems powered on, a low power state with a fast wake-up function, etc.), powered on without video (e.g., a black screen), powered on displaying video (e.g., a moving video, a static picture, text messages, a system user experience, etc.), powered on with a particular on-screen display (a mute icon, a volume button, a specific user interface menu of the television or a device coupled to the television (e.g., an application screen, a settings menu, etc.), etc.), powered on displaying particular content (e.g., a particular television series, a particular series episode, a particular video game, a particular movie, etc.), and/or the like.

Embodiments may determine the state of a consumer electronic device in various ways. For instance, a switching device may determine whether or not a signature signal associated with the consumer electronic device is indicative of a particular state for the consumer electronic device. For example, FIG. 6 is a flowchart 600 of a process for determining whether a signature signal is indicative of a state corresponding to a command, according to an exemplary embodiment. Switching device 204 of FIG. 2 may operate according to flowchart 600 in embodiments. Not all steps of flowchart 600 need be performed in all embodiments. Further structural and operational embodiments will be apparent to persons skilled in the relevant art(s) based on the following description of FIG. 6 with respect to FIG. 2.

Flowchart 600 begins with step 602. In some embodiments, step 602 is a further example of step 302, as described with respect to FIG. 3, a further example of step 504 or 510, as described with respect to FIG. 5, a further example of step 704, as described with respect to FIG. 7, a further example of step 802, as described with respect to FIG. 8, and/or elsewhere herein. In step 602, a signature signal corresponding to a consumer electronic device is received. For instance, switching device 204 of FIG. 2 (or a component thereof) receives a signature signal corresponding to a consumer electronic device, as described elsewhere herein. In accordance with an embodiment, state identification component 216 may transmit request the signature signal and receive the signature signal responsive to transmitting the request. For instance, state identification component 216 may request a reading from a power monitor of power monitors 210, request speakers 208 to play back an audio signal, request camera 250 to capture an image or video, request microphone 242 to capture and/or record audio, request a signal from a remote control device, request data packets from network interface 240, and/or any other type of signature signal from a corresponding component of switching device 204 and/or device coupled to switching device 204, as described herein. Alternatively, signature signals are automatically (e.g., periodically, or continuously) provided to state identification component 216.

In embodiments, one or more of steps 604-610 are further embodiments of step 302 of FIG. 3, step 506 and/or step 508 of FIG. 5, step 706 of FIG. 7, and/or step 804 of FIG. 8.

In step 604, the signature signal is compared to one or more reference signatures. For example, state identification component 216 compares the signature signal to one or more reference signatures. Example reference signatures include, but are not limited to, reference signatures stored in signature file(s) 248, reference signatures stored externally and accessible to switching device 204 (e.g., via network interface 240 and/or a port of ports 234), reference signatures transmitted to a consumer electronic device for playback by the consumer electronic device (e.g., an audio signature transmitted to speakers 208 for playback, a media content signature (e.g., a graphic, an image, a video, etc.) transmitted to a source device for playback and display on a sink device, and/or the like. In embodiments, reference signatures correspond to a state of the consumer electronic device.

In step 606, a determination of whether a level of similarity between the signature signal and the one or more reference signatures meet a threshold condition is made. If the level of similarity meets the threshold condition, flowchart 600 proceeds to step 608. Otherwise, flowchart 600 proceeds to step 610. For example, with reference to FIG. 2, state identification component 216 determines whether a level of similarity between the received power component 216 determines whether a level of similarity between the received power signature signal and the one or more reference power signatures meets a threshold condition. The level of similarity may be determined based on a number of value(s) the received signature signal has that fall within a threshold window for respective values of the reference signature. For instance, state identification component 216 may compare values that represent points on a curve (e.g., of a power signal, of an audio signal, etc.), pixels in an image, frames in a video, and/or the like. In accordance with an embodiment, state identification component 216 assigns a correlation score to the received signature signal based on the determined level of similarity. In this context, the assigned correlation score is compared to a correlation threshold. If the correlation score meets or exceeds the correlation threshold, flowchart 600 proceeds to step 608. Otherwise, flowchart 600 proceeds to step 410.

In some embodiments, step 604 includes comparing the signature signal to a plurality of reference signatures. For instance, state identification component 216 may compare the received signature signal to a plurality of reference signatures corresponding to the same state (e.g., an expected state) and/or a plurality of reference signatures corresponding to respective states. In this context, step 404 includes comparing the signature signal to each of the plurality of reference signatures and step 406 includes determining whether respective levels of similarities between the received signature signal and each respective reference signature meets the threshold condition. Alternatively, steps 404 and 406 include (e.g., sequentially) comparing the signature signal to one of the reference signatures and determining whether a level of similarity between the received signature signal and the one of the reference signatures meets the threshold condition. In this case, if a level of similarity between the received signature signal and the one of the reference signatures meets the threshold condition, flowchart 600 proceeds to step 608 (e.g., without state identification component 216 comparing the signature signal to the remaining reference signatures). Otherwise, state identification component 216 compares the signature signal to the next reference signature of the remaining reference signatures (e.g., until a level of similarity that meets the threshold condition is determined (and flowchart 600 proceeds to step 608) or each of the reference signatures is compared with the signature signal and none of the levels of similarity meet the threshold condition (and flowchart 600 proceeds to step 610)). In accordance with an embodiment where state identification component 216 compares the received signature signal to a plurality of reference signatures corresponding to the same state, step 606 may include determining whether a predetermined number of levels of similarity between the reference signatures and respective ones of the plurality of reference signatures meets the threshold condition (e.g., at least one level of similarity meets the threshold condition, a minimum percentage of levels of similarity meet the threshold condition, etc.). In this context, if a predetermined number of levels of similarity do meet the threshold condition, flowchart 600 proceeds to step 608. Otherwise, flowchart 600 proceeds to step 610.

In step 608, a determination that the signature signal is indicative of the state corresponding to a command is made. For example, state identification component 216 of FIG. 2 determines that the signature signal received in step 602 is indicative of the state corresponding to a command transmitted to the consumer electronic device. Furthermore, state identification component 216 may determine that the consumer electronic device is in the state corresponding to the reference signature(s) corresponding to the level of similarity determined in step 606.

In step 610, a determination that the signature signal is not indicative of the state corresponding to the command is made. For example, state identification component 216 of FIG. 2 determines that the signature signal received in step 602 is not indicative of the state corresponding to the command transmitted to the consumer electronic device. Furthermore, state identification component 216 may determine that the consumer electronic device is not in the state corresponding to the reference signature(s) corresponding to the level of similarity determined in step 606.

Steps 608 and 610 have been described above with respect to determining whether or not a signature signal is indicative of a state corresponding to a command transmitted to the consumer electronic device. Examples of the command include IR command signals, IR codes included in command signals, and other types of commands, as described elsewhere herein. It is further contemplated that switching device 204 of FIG. 2 (or a component thereof) may perform one or more steps of flowchart 600 to determine the state of a consumer electronic device regardless of whether or not a command was transmitted to the consumer electronic device. For instance, in one aspect of the present disclosure, state identification component 216 determines the state of a consumer electronic device as part of a calibration process (e.g., of signature files, of IR blasters 244, etc.). In another aspect of the present disclosure, state identification component 216 determines the state of a consumer electronic device on a periodic basis (e.g., for monitoring states of consumer electronic device, for detecting triggering events, for error detection, etc.). In another aspect of the present disclosure, state identification component 216 determines the state of a consumer electronic device in response to a request from another component of switching device 204 (e.g., action determination component 228, IR calibration component 236, etc.) or another component of system 200 (e.g., a remote control device, a computing device of a user, a computing device of a developer or service technician, etc.).

Additional examples of determining states of consumer electronic devices are described in, for example, U.S. patent application Ser. No. 14/945,201, entitled “Automatic Detection of a Power Status of an Electronic Device and Control Schemes based thereon,” U.S. patent application Ser. No. 17/934,312, entitled “STATE DETECTION VIA POWER MONITORING,” U.S. patent application Ser. No. 17/935,650, entitled “POWER STATE DETECTION VIA AUDIO SIGNAL CAPTURE,” U.S. patent application Ser. No. 16/250,808, entitled “Device Identification and Power State Determination Using Media Device Information,” U.S. patent application Ser. No. 17/866,177, entitled “Determining State Signatures for Consumer Electronic Devices Coupled to an Audio/Video Switch,” and U.S. patent application Ser. No. 15/892,215, entitled “Determining State Signatures for Consumer Electronic Devices Coupled to an Audio/Video Switch,” each of which are incorporated by reference herein in their respective entireties

### VI. Example IR Blaster Component Calibration Embodiments

As discussed above, methods, systems, switching devices, consumer electronic devices, and/or computer storage mediums described herein may (e.g., automatically) calibrate IR blaster components in various ways, in embodiments. For example, FIG. 7 is a flowchart 700 of a process for IR blaster calibration, according to an exemplary embodiment. Switching device 204 of FIG. 2 may operate according to flowchart 700 in embodiments. Not all steps of flowchart 700 need be performed in all embodiments. Further structural and operational embodiments will be apparent to persons skilled in the relevant art(s) based on the following description of FIG. 7 with respect to FIG. 2

Flowchart 700 begins with step 702. In step 702, one or more respective IR signals are transmitted by one or more IR blasters to a consumer electronic device. The one or more respective IR signals correspond to a command For instance, IR blasters 244 of FIG. 2 transmit respective IR command signals to a consumer device (e.g., a source device of source devices 202, a sink device of sink devices 206, a speaker of speakers 208, etc.). Suppose in accordance with an embodiment, the respective IR command signals correspond to a (e.g., same) command For instance, the IR command signals may correspond to a command to perform an action determined by action determination component 228, as described elsewhere herein.

In step 704, a signature signal associated with the consumer electronic device is received. For instance, switching device 204 (or a component thereof) receives a signature signal associated with the consumer electronic device. The signature signal may be any type of signature signal described elsewhere herein. The signature signal may be received via a port of ports 234, via control interface 232, via network 240, via microphone 242, via camera 250, and/or another manner described elsewhere herein.

In step 706, a determination of whether the signature signal is indicative of a state corresponding to the command is made. For instance, state identification component 216 determines whether the signature signal received in step 704 is indicative of a state corresponding to the command associated with the IR command signals transmitted in step 702. As a non-limiting example, suppose the command included instructions for the consumer electronic device to turn off. In this context, state identification component 216 determines whether the signature signal is indicative of a powered off state of the consumer electronic device. State identification component 216 may make this determination as described elsewhere herein, for instance, as described with respect to flowchart 600 of FIG. 6.

In step 708, responsive to determining whether the signature signal is indicative of the state, at least one of the one or more IR blasters is calibrated. For instance, IR calibration component 236 of FIG. 2 calibrates one or more of IR blasters 244 based on the determination made in step 706. Calibration may include, but is not limited to, increasing an output current of an IR blaster, decreasing an output current of an IR blaster, determining which IR blaster(s) to use to transmit IR command signals to the consumer electronic device, determining a maximum output current of an IR blaster suitable for transmitting IR command signals to the consumer electronic device, determining a minimum output current of an IR blaster suitable for transmitting IR command signals to the consumer electronic device, storing IR calibration data for an IR blaster in a storage (e.g., storage 222), and/or any other calibration operations described elsewhere herein and/or as would be understood by a person of skill in the relevant art(s) having benefit of this disclosure.

As discussed above, IR calibration may be performed in various ways. For instance, FIG. 8 is a flowchart 800 of a process for calibrating an IR blaster, according to an exemplary embodiment. In accordance with an embodiment, flowchart 800 is a further example of flowchart 700, as described with respect to FIG. 7. Switching device 204 of FIG. 2 may operate according to flowchart 800 in embodiments. Not all steps of flowchart 800 need be performed in all embodiments. Further structural and operational embodiments will be apparent to persons skilled in the relevant art(s) based on the following description of FIG. 8 with respect to FIG. 2.

Flowchart 800 begins with step 802. Step 802 may include one or more sub-steps preceding steps 804-824 of flowchart 800. In some embodiments, step 802 is a further example of steps 502-504 or 508-510 of flowchart 500, step 604 of flowchart 600, or steps 702-704 of flowchart 700, as respectively described with respect to FIGS. 5A, 6, and 7. In accordance with an embodiment, step 802 is initiated by IR calibration component 236 (e.g., as part of a calibration process, as part of a re-calibration process, as part of corrective action, on a periodic basis, and/or the like). In a non-limiting example, step 802 includes transmitting an IR command signal to a consumer electronic device and (e.g., subsequently) receiving a signature signal associated with the consumer electronic device. Steps 804-822 of flowchart 800 are described as follows with respect to this non-limiting example; however, embodiments disclosed herein are not so limited. Furthermore, steps 804-822 of flowchart 800 are described with respect to calibrating a single IR blaster (e.g., of IR blasters 244), however it is also contemplated herein that multiple IR blasters may be calibrated, simultaneously or sequentially.

In step 804, a determination of whether a signature signal is indicative of a state corresponding to a command is made. For instance, state identification component 216 of FIG. 2 determines whether a signature signal associated with a consumer electronic device received by switching device 204 (or a component thereof) is indicative of a state corresponding to an IR command signal transmitted to the consumer electronic device. State identification component 216 may make this determination using techniques described elsewhere herein (e.g., as described with respect to flowchart 600 of FIG. 6). If the signature signal is indicative of the state, flowchart 800 proceeds to step 818. Otherwise, flowchart 800 proceeds to step 806.

In step 806, a determination of whether an error threshold condition has been met is made. For example, IR calibration component 236 determines if an error threshold condition has been met. For instance, IR calibration component 236 may track (e.g., by temporarily storing a value and/or increasing a count value) how many times state identification component 216 has determined that a received signature signal is not indicative of a state corresponding to one or more commands issued to the consumer electronic device (e.g., during the IR calibration process). If the number of times exceeds a (e.g., predetermined) error threshold condition, flowchart 800 proceeds to step 808. Otherwise, flowchart 800 proceeds to step 810. By tracking how many times state identification component 216 has determined that a received signature signal is not indicative of the state (e.g., during the IR calibration process), IR calibration component 236 is able to determine error events. Example error events include, but are not limited to, a device failure (e.g., of switching device 204, of the consumer electronic device, of a remote control device, of power monitors 210, of another consumer electronic device in system 200), a communication failure (e.g., an interruption in a communication signal, a blocked receiver or transmitter, a damaged receiver or transmitter, etc.), a software error, a corrupted file (e.g., a corrupted signature file of signature files 248, a corrupted codeset map file, etc.), and/or any other type of error that would cause the error threshold condition to be met, as would be understood by a person of skill in the relevant art(s) having benefit of this disclosure.

In step 808, a corrective action is performed. For example, responsive to having determined that an error threshold condition is met, state identification component 216 performs a corrective action, requests another component of switching device 204 to perform a corrective action, and/or requests another device (e.g., of system 200 or coupled to system 200 over a network) to perform a corrective action. Corrective actions may include, but are not limited to, sending a request for a new signature signal, analyzing a new signature signal, recalibrating via signature calibration component 238, reporting an error to a service team (e.g., via a wireless connection (e.g., via network interface 240), e-mail, text message, etc.), reporting an error to a user (e.g., via one or more sink devices of sink devices 206, one or more source devices of source devices 202, switching device 204, one or more power monitors of power monitors 210, network interface 240, an e-mail, an app notification, a text message, etc.), and/or sending a command to the consumer electronic device to enter a state. In accordance with an embodiment, switching device 204 performs and/or requests multiple corrective actions simultaneously or sequentially. For example, switching device 204 may first request and analyze a new signature signal. If a level of similarity between the new signature signal and one or more reference signatures does not meet a threshold condition, switching device 204 may recalibrate signature file(s) 248. Once calibrated, an updated new signature signal is analyzed. If the updated new signature signal does not match any reference signature, an error is reported to the user and/or a service team.

As stated above, an example of a corrective action includes reporting an error to a user (e.g., via one or more sink devices of sink devices 206, one or more source devices of source devices 202, switching device 204, one or more power monitors of power monitors 210, network interface 240, an e-mail, an app notification, a text message, etc.). For instance, a switching device 204 may report an error to a user indicating that a command was not processed correctly (e.g., due to a failure of the consumer electronic device, switching device 204, an IR blaster of IR blasters 244, and/or a remote control device associated with the consumer electronic device). In accordance with an embodiment, the error indicates that calibration of the one or more IR blasters failed.

In step 810, a determination of whether an IR receiver of the consumer electronic device is saturated is made. For example, IR calibration component 236 of FIG. 2 determines whether an IR receiver of the consumer electronic device is saturated. If the IR receiver is saturated, flowchart 800 proceeds to step 812. Otherwise, flowchart 800 proceeds to step 814. In accordance with an embodiment, IR calibration component 236 makes the determination based on an error message (e.g., an error notification or an error code) received from the consumer electronic device (e.g., by a port of ports 234 to which the consumer electronic device, by control interface 232, by network interface 240, by microphone 242, and/or by camera 250. In accordance with an embodiment, the error message is received from another consumer electronic device (e.g., a speaker coupled to the consumer electronic device emitting an audio error notification, a notification displayed on a sink device coupled to the consumer electronic device). In accordance with an embodiment, the error message is received from a remote control device (e.g., by control interface 232). In accordance with one or more embodiments, IR calibration component 236 determines if the IR receiver is saturated by a trial-and-error method to determine a maximum current that an IR signal may be projected without saturating the IR receiver.

In step 812, the output current of the IR blaster is decreased and flowchart 800 proceeds to step 816. For instance, IR calibration component 236 decreases the output current of the IR blaster of IR blasters 244. In accordance with an embodiment, IR calibration component 236 decreases the output current of the IR blaster by a set amount (e.g., a number of milliamps, a number of amps, a percentage of the currently set current, a percentage of maximum output current of the IR blaster, etc.). In accordance with another embodiment, IR calibration component 236 decreases the output current of the IR blaster to a predetermined level (e.g., of multiple predetermined levels). In accordance with an embodiment, IR calibration component 236 decreases the output current of multiple IR blasters by the same amount or by respective (e.g., different) amounts. In accordance with an embodiment, IR calibration component 236 stores (e.g., temporarily) an indication of the presently set output current of the IR blaster(s) of IR blasters 244.

In step 814, the output current of the IR blaster is increased and flowchart 800 proceeds to step 816. For instance, IR calibration component 236 increases the output current of the IR blaster of IR blasters 244. In accordance with an embodiment, IR calibration component 236 increases the output current of the IR blaster by a set amount (e.g., a number of milliamps, a number of amps, a percentage of the currently set current, a percentage of maximum output current of the IR blaster, etc.). In accordance with another embodiment, IR calibration component 236 increases the output current of the IR blaster to a predetermined level (e.g., of multiple predetermined levels). In accordance with an embodiment, IR calibration component 236 increases the output current of multiple IR blasters by the same amount or by respective (e.g., different) amounts. In accordance with an embodiment, IR calibration component 236 stores (e.g., temporarily) an indication of the presently set output current of the IR blaster(s) of IR blasters 244.

In step 816, the command is reissued. For example, the IR blaster of IR blasters 244 transmits the IR command signal to the consumer electronic device (i.e., at the adjusted output current). In accordance with an embodiment, the IR command signal comprises the same instructions (e.g., IR code(s) of an IR codeset) to perform an action as the IR command signal previously transmitted to the consumer electronic device. Alternatively, the IR command signal comprises instructions to perform a different action, e.g., an action associated with calibrating IR blasters 244.

In step 818, a determination of whether a maximum output current has been determined is made. For instance, IR calibration component 236 of FIG. 2 determines whether a maximum output current associated with the IR blaster of IR blasters 244 has been determined. In this context, the maximum output current associated with the IR blaster is the maximum magnitude of output current consumed by the IR blaster to project IR light that results in the consumer electronic device entering a state corresponding to an IR command signal transmitted to the consumer electronic device by the IR blaster. If a maximum output current has been determined, flowchart 800 proceeds to step 820. Otherwise, flowchart 800 proceeds to step 814.

As a first non-limiting example, suppose state identification component 216 determined a first IR command signal transmitted using a first output current of the IR blaster did not result in a (e.g., first) signature signal indicative of the state (e.g., as in step 804) and IR calibration component 236 determined the IR receiver was saturated (e.g., as in step 810). In this context, IR calibration component 236 decreased the output current of the IR blaster (e.g., as in step 812) before reissuing the command (e.g., as in step 816) as a second IR command signal. Therefore, the second IR command signal is transmitted using a second output current of the IR blaster, lower than the first output current. In this example, a second signature signal is received (e.g., as in step 802) and state identification component 216 determines (e.g., as in step 804) that the second signature signal is indicative of the state corresponding to the second IR command signal. In this context, IR calibration component 236 determines that the second output current of the IR blaster is a maximum output current suitable for transmitting IR command signals to the consumer electronic device by the IR blaster and flowchart 800 proceeds to step 820. In accordance with an embodiment, IR calibration component 236 may repeat this process for each IR blaster of IR blasters 244.

In a second non-limiting example, suppose state identification component 216 determined a first IR command signal transmitted using a first output current of the IR blaster did result in a (e.g., first) signature signal indicative of the state (e.g., as in step 804) and IR calibration component 236 determined that a maximum output current has not yet been determined (e.g., as in step 818). In this context, IR calibration component 236 increases the output current of the IR blaster (e.g., as in step 814) before reissuing the command (e.g., as in step 816) as a second IR command signal. Therefore, the second IR command signal is transmitted using a second output current of the IR blaster, greater than the first output current. In this example, a second signature signal is received (e.g., as in step 802), state identification component 216 determines (e.g., as in step 804) that the second signature signal is not indicative of the state corresponding to the second IR command signal, and IR calibration component determines that the IR receiver of the consumer electronic device is saturated (e.g., as in step 810). In this context, IR calibration component 236 determines that the first output current of the IR blaster is a maximum output current suitable for transmitting IR command signals to the consumer electronic device by the IR blaster. Depending on the implementation, flowchart 800 may proceed to step 820 (e.g., subsequent to the determination made in step 810). Alternatively, flowchart 800 proceeds to step 812, where the output current is lowered to the first output current, step 816, where the command is reissued, step 802, where a third signature signal is received, step 804, where the determination that the third signature signal is indicative of the state is made, and step 818, where the determination that the maximum output current is made. and flowchart 800 proceeds to step 820. In accordance with an embodiment, IR calibration component 236 may repeat this process for each IR blaster of IR blasters 244.

In step 820, a determination of whether a minimum output current has been determined is made. For instance, IR calibration component 236 determines whether a minimum output current associated with the IR blaster of IR blasters 244 has been determined. In this context, the minimum output current associated with the IR blaster is the minimum magnitude of output current consumed by the IR blaster to project IR light that results in the consumer electronic device entering a state corresponding to the IR command signal transmitted to the consumer electronic device by the IR blaster. If a minimum output current has been determined, flowchart 800 proceeds to step 820. Otherwise, flowchart 800 proceeds to step 812.

As a non-limiting example, suppose IR calibration component 236 previously increased the output current of the IR blaster (e.g., as in step 814) in response to the state identification component 216 determining (e.g., as in step 804) that a signature signal is not indicative of a state corresponding to a first IR command signal that was transmitted to a consumer electronic device at a first output current, and to IR calibration component 236 determining (e.g., as in step 810) that the IR receiver of the consumer electronic device was not saturated. In this context, a second IR command signal is transmitted to the consumer electronic device using a second output current, greater than the first output current (e.g., as in step 816). In this example, a second signature signal is received (e.g., as in step 802) and state identification component 216 determines (e.g., as in step 804) that the second signature signal is indicative of the state corresponding to the second IR command signal. In this context, IR calibration component 236 determines that the second output current of the IR blaster is a minimum output current suitable for transmitting IR command signals to the consumer electronic device by the IR blaster and flowchart 800 proceeds to step 822. In accordance with an embodiment, IR calibration component 236 may repeat this process for each IR blaster of IR blasters 244. A similar process may be performed for decreasing the output current of the IR blaster (e.g., as in step 812) until a signature signal is received that does not indicate a state corresponding to a respective IR command signal.

As discussed above with respect to steps 818 and 820, IR calibration component 236 may perform various steps (e.g., in conjunction with one or more other components of switching device 204) in order to determine the maximum output current or minimum output current for transmitting IR command signals from an IR blaster to a consumer electronic device. In accordance with an embodiment, the maximum or minimum output currents may be a maximum or minimum, respectively, output current setting for the IR blaster (e.g., rather than an exact maximum or minimum current magnitude). Furthermore, the maximum or minimum output currents may represent ranges of current magnitudes, or current magnitudes with a tolerance adjustment.

In step 822, IR blaster calibration data is stored. For example, IR calibration component 236 stores the maximum output current and/or minimum output current for an IR blaster of IR blasters 244 as IR blaster calibration data. In embodiments, IR calibration component 236 may store the IR blaster calibration data in storage 222, in an external storage connected to a port of ports 234, in a network-accessible storage accessible via network interface 240, and/or the like. In accordance with one or more embodiments, IR blaster calibration data is stored in a table or map. IR blaster calibration data may include identifiers of the consumer electronic device, the maximum and/or minimum current settings for an IR blaster to transmit IR command signals to the consumer electronic device, which IR blasters of IR blasters 244 are to be used to transmit IR command signals to the consumer electronic device, IR codesets suitable for controlling the consumer electronic device, and/or any other information associated with consumer electronic devices, IR blasters 244, switching device 204, and/or the like, as described herein.

Flowchart 800 ends with step 824. In step 824, the IR calibration process is complete. Step 824 may include additional sub-steps, not shown in FIG. 8. For instance, in accordance with an embodiment, step 824 includes transmitting a notification that calibration is complete. In accordance with another embodiment, step 824 includes returning to step 802 and calibrating a different IR blaster of IR blasters 244, calibrating one or more IR blasters for a different consumer electronic device, and/or otherwise restarting the calibration process. In accordance with another embodiment, step 824 includes entering a standby mode where switching device 204 monitors for triggering events.

### VII. Further Example IR Coverage, Selection, and Calibration Embodiments

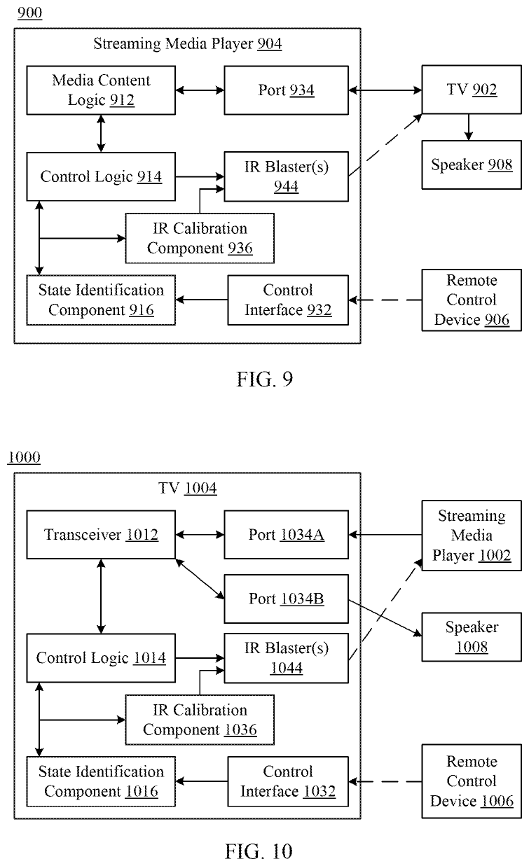

Exemplary embodiments have been described above with respect to a switching device (e.g., switching device 204 of FIG. 2) that is configured to provide IR cover, select an IR codeset, and/or calibrate an IR blaster. However, one or more embodiments described herein may be incorporated in any other device, or as a stand-alone device, configured to provide IR cover, select an IR codeset, and/or calibrate an IR blaster. For instance, a source device in accordance with an embodiment may be configured to provide IR cover, select an IR codeset, and/or calibrate an IR blaster. For example, FIG. 9 is a block diagram of a media system 900 (“system 900” hereinafter) configured for IR coverage, selection, and/or calibration, according to another exemplary embodiment. System 900 is an example of system 100A and/or 100B, as described above with reference to FIGS. 1A and 1B. System 900 includes a sink device 902 (“TV 902” hereinafter), a source device 904 (“streaming media player 904” hereinafter), a remote control device 406, and a speaker 908. TV 902, remote control device 406, and speaker 908 are examples of consumer electronic device 102D, remote control device 106, and speakers 108 of FIGS. 1A and 1B, respectively. In accordance with an embodiment, system 900 may include a switching device (such as switching device 104A of FIG. 1A, switching device 104B of FIG. 1B or switching device 204 of FIG. 2) coupled between streaming media player 904 and TV 902, not shown in FIG. 9. In accordance with another embodiment, such switching device is incorporated in streaming media player 904.

As shown in FIG. 9, streaming media player 904 includes media content logic 912, control logic 914, state identification component 916, control interface 932, port 934, IR calibration component 936, and one or more IR blasters 944 (“IR blasters 944” hereinafter). State identification component 916, control logic 914, control interface 932, IR calibration component 936, and IR blasters 944 operate in similar respective manners as state identification component 216, control logic 918, control interface 232, IR calibration component 236, and IR blasters 244, as described above with respect to FIG. 2. In accordance with one or more embodiments, streaming media player 904 includes additional components not shown in FIG. 9. For instance, streaming media player 904 in accordance with an embodiment includes components that operate similar to transceiver 212, first mapping component 214, processors 220, storage 222, switching circuit 224, identification component 226, action determination component 228, second mapping component 230, signature calibration component 238, network interface 240, microphone 242, and/or camera 250, as described above with respect to FIG. 2. In accordance with one or more embodiments, any of these components may be integrated as a subcomponent of control logic 914, or another component of streaming media player 904. While a single port 934 is shown in FIG. 9, embodiments of streaming media player 902 may include any number of ports, as described herein.

Media content logic 912 is configured to provide media content signals to TV 902 via port 934. For example, a user (via remote control device 406) may interact, view, search, and/or select content for media content logic 912 to provide to TV 902. In embodiments, media content logic 912 may access media content over a network via network interface (not shown) to provide the media content signals.

As described above, control logic 914 operates in a similar manner as control logic 918 of FIG. 2. Furthermore, control logic 914 controls media content logic 912 (e.g., based on input received via remote control device 906, via control interface 932, via a network interface, according to actions determined by an action determination component (not shown), states determined by state identification component 916, adjustments to IR blasters by IR calibration component 936, responsive to triggering events, etc.).

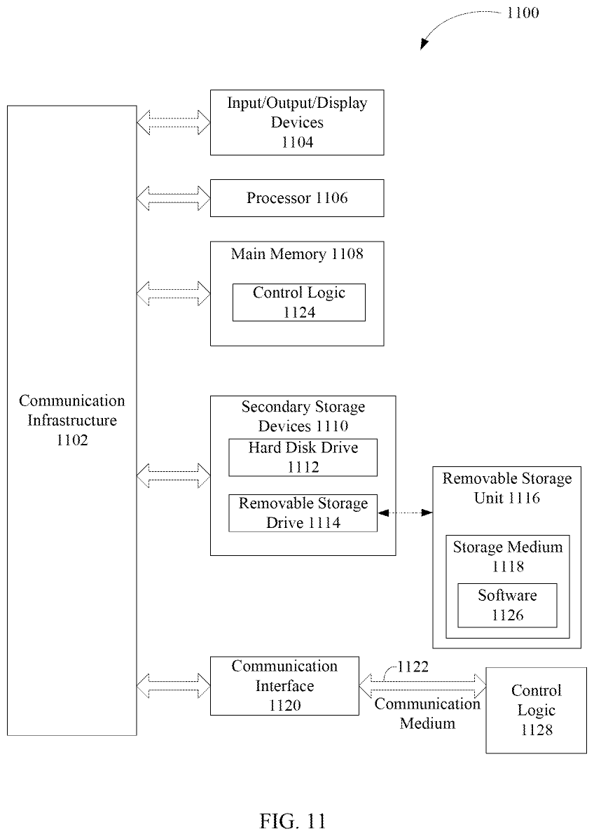

As described above, one or more embodiments may be incorporated in a device other than a switching device configured to calibrate a speaker or microphone via audio signal capture. For instance, a media presentation device in accordance with an embodiment may be configured to calibrate a speaker or microphone via audio signal capture. For example, FIG. 10 is a block diagram of a media system 1000 (“system 1000” hereinafter) configured for IR coverage, selection, and/or calibration, according to another exemplary embodiment. System 1000 is an example of system 100A and/or 100B, as described above with reference to FIGS. 1A and 1B. System 1000 includes a source device 1002 (“streaming media player 1002” hereinafter), a sink device 1004 (“TV 1004” hereinafter), a remote control device 1006, and a speaker 1008. Streaming media player 1002, remote control device 1006, and remote control device 1006 are examples of consumer electronic device 102C, remote control device 106, and speakers 108 of FIGS. 1A and 1B, respectively. In accordance with an embodiment, system 1000 may include a switching device (such as switching device 104A of FIG. 1A, switching device 104B of FIG. 1B, or switching device 204 of FIG. 2) coupled between TV 1004 and streaming media player 1002, not shown in FIG. 10. In accordance with another embodiment, such switching device is incorporated in TV 1004.

As shown in FIG. 10, TV 1004 includes transceiver 1012, control logic 1014, state identification component 1016, control interface 1032, port 1034A, port 1034B, IR calibration component 1036, and one or more IR blasters 1044 (“IR blasters 1044” hereinafter). State identification component 1016, control logic 1014, control interface 1032, IR calibration component 1036, and IR blasters 1044 operate in similar respective manners as state identification component 216, control logic 918, control interface 232, IR calibration component 236, and IR blasters 244, as described above with respect to FIG. 2. In accordance with one or more embodiments, TV 1004 includes additional components not shown in FIG. 10. For instance, TV 1004 in accordance with an embodiment includes components that operate similar to first mapping component 214, processors 220, storage 222, switching circuit 224, identification component 226, action determination component 228, second mapping component 230, signature calibration component 238, network interface 240, microphone 242, and/or camera 250, as described above with respect to FIG. 2. In accordance with one or more embodiments, any of these components may be integrated as a subcomponent of control logic 1014, or another component of TV 1004. While two ports 1034A and 1034B are shown in FIG. 10, embodiments of TV 1004 may include any number of ports (e.g., fewer than 2, greater than 2, etc.), as described herein. Furthermore, while speaker 1008 is shown external to TV 1004, in accordance with another embodiment, speaker 1008 is integrated in TV 1004.

Transceiver 1012 is configured to receive media content signals from streaming media player 1002 via port 1034A for display on a screen of TV 1004 (not shown in FIG. 10). Furthermore, transceiver 1012 is configured to provide audio signals of received media content signals to speakers 1008 via port 1034B. In some embodiments, transceiver 1016 may also be configured to send commands to streaming media player 1002 from control logic 1014 via port 1034A or to speaker 1008 via port 1034B. In some embodiments, transceiver 1012 performs similar functions to transceiver 212 of FIG. 2.

As described above, control logic 1014 operates in a similar manner as control logic 218 of FIG. 2. Furthermore, control logic 1014 may access signals (e.g., media content signals) received by or provided by transceiver 1012, transmit commands to streaming media player 1002 and/or speakers 1008 via transceiver 1012, and/or the like. Control logic 1014 may perform one or more of these functions, for example, based on input received via remote control device 1006, via control interface 1032, via a network interface, according to actions determined by an action determination component (not shown), states determined by state identification component 1016, adjustments to IR blasters 1044 by IR calibration component 1036, responsive to triggering events, and/or the like.

### VIII. Further Example Embodiments and Advantages

One or more embodiments described herein may perform their functions according to the flowcharts described herein. Additional structural and operational embodiments will be apparent to persons skilled in the relevant art(s) based on the discussions regarding the flowcharts and embodiments herein. In some example embodiments, one or more of the steps of the described flowcharts may not be performed. Moreover, steps in addition to or in lieu of the steps of the described flowcharts may be performed (some of which were described above). Further, in some example embodiments, one or more of the steps of the described flowcharts may be performed out of the order shown or described, in an alternate sequence, and/or partially (or completely) concurrently with other steps.

Reference signatures may be stored in various storages internal and/or external to a system, in embodiments. For example, embodiments described herein describe reference signatures stored in signature file(s) 248 in storage(s) 222 of switching device 204. However, it is further contemplated that reference signatures may be stored external to switching device 204. For example, reference signatures may be stored in an external storage device (e.g., a SD (Secure Digital) card, an external hard drive, a flash drive, etc.) and/or a cloud network. In accordance with an embodiment where reference signatures are stored in a cloud network, reference power signatures may be shared between multiple switching devices. For example, reference signatures may be made anonymous and stored in a cloud network operated by a service provider (e.g., manufacturer of switching device 204). In this context, other switching devices may access reference signatures stored in the cloud network. In this way, the signature calibration process of a switching device (e.g., switching device 204) may be expedited. For example, during the signature calibration process, signature calibration component 238 may determine that one of sink device(s) 206 has one or more reference signatures stored in a cloud network. In this example, signature calibration component 238 may skip the calibration process for the states associated with the reference signatures stored in the cloud network. In accordance with an embodiment, signature calibration component 238 may copy reference signatures stored in the cloud network to signature file(s) 248. Similar techniques may be used by IR calibration component 236 to calibrate IR blasters with respect to IR blaster calibration data. Furthermore, similar techniques may be used by action determination component 228 for determining an IR codeset suitable for controlling a particular consumer electronic device with respect to codeset maps.

It is also noted that while the embodiments described above disclose IR coverage, IR codeset selection, and/or IR blaster calibration performed by a switching device (e.g., switching device 104A, as shown in FIG. 1A, switching device 104B, as shown in FIG. 1B, and/or switching device 204, as shown in FIG. 2), a source device (e.g., streaming media player 904, as shown in FIG. 9), and/or a sink device (e.g., TV 1004, as shown in FIG. 10, the embodiments described herein are not so limited. For instance, such embodiments may be performed by a standalone device communicatively coupled to source device(s), sink device(s), power monitors(s), and/or switching device. In another example, the embodiments described herein may be performed via a network-based service (e.g., a cloud-based service) configured to analyze data provided by a media system (e.g., system 100A of FIG. 1A, system 100B of FIG. 1B, system 200 of FIG. 2, system 900 of FIG. 9, and/or system 1000 of FIG. 10) to select IR codesets and/or calibrate IR blasters. The embodiments described herein and/or any further systems, sub-systems, devices and/or components disclosed herein may be implemented in hardware (e.g., hardware logic/electrical circuitry), or any combination of hardware with software (computer program code configured to be executed in one or more processors or processing devices) and/or firmware.

The embodiments described herein, including systems, methods/processes, devices, and/or apparatuses, may be implemented using well known processing devices, telephones (smart phones and/or mobile phones), tablet computers, servers, and/or, computers, such as a computer 1100 shown in FIG. 11. It should be noted that computer 1100 may represent communication devices, processing devices, servers, and/or traditional computers in one or more embodiments. For example, the techniques and/or systems for providing IR cover, selecting an IR codeset, determining states of consumer electronic devices, and/or calibrating IR blaster(s), and any of the sub-steps and/or sub-systems, may be implemented using one or more computers 1100 or portions thereof.

Computer 1100 can be any commercially available and well known communication device, processing device, and/or computer capable of performing the functions described herein, such as devices/computers available from International Business Machines®, Apple®, Sun®, HP®, Dell®, Cray®, Samsung®, Nokia®, etc. Computer 1100 may be any type of computer, including a desktop computer, a server, etc.

Computer 1100 includes one or more processors (also called central processing units, or CPUs), such as a processor 1106. Processor 606 is connected to a communication infrastructure 1102, such as a communication bus. In some embodiments, processor 1106 can simultaneously operate multiple computing threads.

Computer 1100 also includes a primary or main memory 1108, such as random access memory (RAM). Main memory 1108 has stored therein control logic 1124 (computer software), and data.

Computer 1100 also includes one or more secondary storage devices 1110. Secondary storage devices 1110 include, for example, a hard disk drive 1112 and/or a removable storage device or drive 1114, as well as other types of storage devices, such as memory cards and memory sticks. For instance, computer 1100 may include an industry standard interface, such a universal serial bus (USB) interface for interfacing with devices such as a memory stick. Removable storage drive 1114 represents a floppy disk drive, a magnetic tape drive, a compact disk drive, an optical storage device, tape backup, etc.

Removable storage drive 1114 interacts with a removable storage unit 1116. Removable storage unit 1116 includes a computer useable or readable storage medium 1118 having stored therein computer software 1126 (control logic) and/or data. Removable storage unit 1116 represents a floppy disk, magnetic tape, compact disk, DVD, optical storage disk, or any other computer data storage device. Removable storage drive 1114 reads from and/or writes to removable storage unit 1116 in a well-known manner

Computer 1100 also includes input/output/display devices 1104, such as touchscreens, LED and LCD displays, monitors, keyboards, pointing devices, etc.

Computer 1100 further includes a communication or network interface 1120. Communication interface 1120 enables computer 1100 to communicate with remote devices. For example, communication interface 1120 allows computer 1100 to communicate over communication networks or mediums 1122 (representing a form of a computer useable or readable medium), such as LANs, WANs, the Internet, etc. Network interface 1120 may interface with remote sites or networks via wired or wireless connections.

Control logic 1128 may be transmitted to and from computer 1100 via the communication medium 1122.

Any apparatus or manufacture comprising a computer useable or readable medium having control logic (software) stored therein is referred to herein as a computer program product or program storage device. This includes, but is not limited to, computer 1100, main memory 1108, secondary storage devices 1110, and removable storage unit 1116. Such computer program products, having control logic stored therein that, when executed by one or more data processing devices, cause such data processing devices to operate as described herein, represent embodiments of the invention.

Techniques, including methods, and embodiments described herein may be implemented by hardware (digital and/or analog) or a combination of hardware with one or both of software and/or firmware. Techniques described herein may be implemented by one or more components. Embodiments may comprise computer program products comprising logic (e.g., in the form of program code or software as well as firmware) stored on any computer useable medium, which may be integrated in or separate from other components. Such program code, when executed by one or more processor circuits, causes a device to operate as described herein. Devices in which embodiments may be implemented may include storage, such as storage drives, memory devices, and further types of physical hardware computer-readable storage media. Examples of such computer-readable storage media include, a hard disk, a removable magnetic disk, a removable optical disk, flash memory cards, digital video disks, random access memories (RAMs), read only memories (ROM), and other types of physical hardware storage media. In greater detail, examples of such computer-readable storage media include, but are not limited to, a hard disk associated with a hard disk drive, a removable magnetic disk, a removable optical disk (e.g., CDROMs, DVDs, etc.), zip disks, tapes, magnetic storage devices, MEMS (micro-electromechanical systems) storage, nanotechnology-based storage devices, flash memory cards, digital video discs, RAM devices, ROM devices, and further types of physical hardware storage media. Such computer-readable storage media may, for example, store computer program logic, e.g., program modules, comprising computer executable instructions that, when executed by one or more processor circuits, provide and/or maintain one or more aspects of functionality described herein with reference to the figures, as well as any and all components, capabilities, and functions therein and/or further embodiments described herein.

Such computer-readable storage media are distinguished from and non-overlapping with communication media and transitory signals (do not include communication media and transitory signals). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media and signals transmitted over wired media. Embodiments are also directed to such communication media.

The techniques and embodiments described herein may be implemented as, or in, various types of devices. For instance, embodiments may be included, without limitation, in processing devices (e.g., illustrated in FIG. 11) such as computers and servers, as well as communication systems such as switches, routers, gateways, and/or the like, communication devices such as smart phones, home electronics, gaming consoles, entertainment devices/systems, etc. A device, as defined herein, is a machine or manufacture as defined by 35 U.S.C. § 101. That is, as used herein, the term “device” refers to a machine or other tangible, manufactured object and excludes software and signals. Devices may include digital circuits, analog circuits, or a combination thereof. Devices may include one or more processor circuits (e.g., central processing units (CPUs), processor 1106 of FIG. 11), microprocessors, digital signal processors (DSPs), and further types of physical hardware processor circuits) and/or may be implemented with any semiconductor technology in a semiconductor material, including one or more of a Bipolar Junction Transistor (BJT), a heterojunction bipolar transistor (HBT), a metal oxide field effect transistor (MOSFET) device, a metal semiconductor field effect transistor (MESFET) or other transconductor or transistor technology device. Such devices may use the same or alternative configurations other than the configuration illustrated in embodiments presented herein.

### IX. CONCLUSION

While various embodiments have been described above, it should be understood that they have been presented by way of example only, and not limitation. It will be apparent to persons skilled in the relevant art that various changes in form and detail can be made therein without departing from the spirit and scope of the embodiments. Thus, the breadth and scope of the embodiments should not be limited by any of the above-described exemplary embodiments, but should be defined only in accordance with the following claims and their equivalents.

What is claimed is:

1. A switching device, comprising:
a plurality of ports, at least one of the plurality of ports communicatively coupled to a first consumer electronic device; and
a plurality of infrared (IR) blaster components oriented to project IR light in different directions;
the switching device configured to:
detect a triggering event;
responsive to the detection, determine an action to be performed by the first consumer electronic device;
determine that the first consumer electronic device is controllable using IR signals;
transmit, by the plurality of IR blaster components, a first IR command signal to the first consumer electronic device, the first IR command signal comprising instructions to perform the determined action.

2. The switching device of claim 1, wherein the triggering event comprises at least one of:
the switching device receiving a command via a network interface;
the switching device detecting a wireless control signal sent from a remote control device;
a change in a state of the first consumer electronic device; or
a change in a state of a second consumer electronic device.

3. The switching device of claim 1, wherein:
the action to be performed by the first consumer electronic device comprises entering a state; and
the first IR command signal comprises instructions to enter the state.

4. The switching device of claim 3, wherein the switching device is further configured to:
responsive to the transmission of the first IR command signal, determine that the first consumer electronic device is not in the state;
responsive to the determination that the first consumer electronic device is not in the state, perform a corrective action.

5. The switching device of claim 4, wherein to perform the corrective action, the switching device is further configured to recalibrate at least one IR blaster of the plurality of IR blasters.

6. The switching device of claim 4, wherein the first IR command signal comprises a first IR code of a first IR codeset, and to perform the corrective action, the switching device is further configured to:
transmit, to the first consumer electronic device, a second IR command signal comprising a second IR code of a second IR codeset;
determine that the first consumer electronic device is in the state; and
associate the second IR codeset with the first consumer electronic device.

7. The switching device of claim 1, wherein the switching device is configured to:
determine an IR codeset associated with the first consumer electronic device based on a codeset map; and
transmit, by the plurality of IR blaster components, the first IR command signal to the first consumer electronic device based on the determined IR codeset.

8. A system, comprising:
an infrared (IR) blaster component operable to transmit IR signals to a plurality of consumer electronic devices;
a state identification component operable to determine the state of the plurality of consumer electronic devices;
the system configured to:
transmit, by the IR blaster component, a first IR command signal to a consumer electronic device of the plurality of consumer electronic devices, the first IR command signal comprising a first IR code of a first IR codeset;
receive a first signature signal associated with the consumer electronic device;
determine, by the state identification component, that the first signature signal is not indicative of a first state corresponding to the first IR command signal;
responsive to the determination that the first signature signal is not indicative of the first state, transmit, by the IR blaster component, a second IR command signal to the consumer electronic device, the second IR command signal comprising a second IR code of a second IR codeset;
receive a second signature signal associated with the consumer electronic device;
determine, by the state identification component, that the second signature signal is indicative of a second state corresponding to the second IR command signal; and
associate the second IR codeset with the consumer electronic device.

9. The system of claim 8, wherein to associate the second IR codeset with the consumer electronic device, the system is configured to store an association between the second IR codeset and the consumer electronic device in a codeset map.

10. The system of claim 8, wherein the system is configured to transmit to the consumer electronic device, by the IR blaster component, subsequent IR command signals based on IR codes of the second IR codeset.

11. The system of claim 8, wherein to determine the second signature signal is indicative of the second state corresponding to the second IR command signal, the state identification component is configured to:
compare the second signature signal to one or more reference signatures; and
determine that a level of similarity between the second signature signal and the one or more reference signatures meets a threshold condition.

12. The system of claim 8, further comprising a plurality of IR blaster components, the plurality of IR blaster components comprising the IR blaster component, the plurality of IR blaster components oriented to project IR light in different directions; and
wherein the system is configured to transmit the first IR command signal and the second IR command signal utilizing the plurality of IR blaster components.

13. The system of claim 8, wherein the first state and the second state are the same state.

14. A method performed by a switching device comprising a plurality of ports and a plurality of infrared (IR) blaster components, at least one of the plurality of ports communicatively coupled to a first consumer electronic device, the plurality of IR blaster components oriented to project IR light in different directions, the method comprising:
detecting a triggering event;
responsive to detecting the triggering event, determining an action to be performed by the first consumer electronic device;
determining that the first consumer electronic device is controllable using IR signals;
transmitting, by the plurality of IR blaster components, an IR command signal to the first consumer electronic device, the IR command signal comprising instructions to perform the determined action.

15. The method of claim 14, wherein the triggering event comprises at least one of:
the switching device receiving a command via a network interface;
the switching device detecting a wireless control signal sent from a remote control device;
a change in a state of the first consumer electronic device; or
a change in a state of a second consumer electronic device.

16. The method of claim 14, wherein:
the action to be performed by the first consumer electronic device comprises entering a state; and
the first IR command signal comprises instructions to enter the state.

17. The method of claim 16, further comprising:
responsive to transmitting the first IR command signal, determining that the first consumer electronic device is not in the state;
responsive to determining that the first consumer electronic device is not in the state, performing a corrective action.

18. The method of claim 17, wherein said performing the corrective action comprises recalibrating at least one IR blaster of the plurality of IR blasters.

19. The method of claim 17, wherein the first IR command signal comprises a first IR code of a first IR codeset, and said performing the corrective action comprises:
transmitting, to the first consumer electronic device, a second IR command signal comprising a second IR code of a second IR codeset;
determining that the first consumer electronic device is in the state; and
associating the second IR codeset with the first consumer electronic device.

20. The method of claim 14, further comprising:
determining an IR codeset associated with the first consumer electronic device based on a codeset map; and
transmitting, by the plurality of IR blaster components, the first IR command signal to the first consumer electronic device based on the determined IR codeset.
